(19) United States
(12) Patent Application Publication
(10) Pub. No.: US 2024/0396636 A1
(43) Pub. Date: Nov. 28, 2024

(54) COMMUNICATION DEVICE AND COMMUNICATION SYSTEM

(71) Applicant: NEC Corporation, Minato-ku, Tokyo (JP)

(72) Inventors: Koya TAKATA, Tokyo (JP); Hisashi Mizumoto, Tokyo (JP); Fujio Okumura, Kanagawa (JP)

(73) Assignee: NEC Corporation, Minato-ku, Tokyo (JP)

(21) Appl. No.: 18/697,092

(22) PCT Filed: Nov. 11, 2021
(86) PCT No.: PCT/JP2021/041482

§ 371 Date: Mar. 29, 2024

(51) Int. Cl. H04B 10/40; H04B 10/11; H04B 10/532

(52) U.S. Cl. CPC H04B 10/40; H04B 10/11; H04B 10/532

(57) ABSTRACT

A communication system that includes a plurality of communication devices, each including a first transmission/reception unit that transmits and receives counterclockwise first circularly polarized optical signals as spatial optical signals and a second transmission/reception unit that transmits and receives clockwise second circularly polarized optical signals as spatial optical signals, in which the plurality of communication devices is arranged in such a way that, among the first transmission/reception units and the second transmission/reception units, transmission/reception units that transmit and receive circularly polarized optical signals rotating in the same direction face each other between each of the communication devices and another communication device that is a communication counterpart.

### TECHNICAL FIELD

The present disclosure relates to a communication system that performs optical spatial communication using optical signals propagating in a space.

### BACKGROUND ART

In optical spatial communication, optical signals propagating in a space (hereinafter also referred to as spatial optical signals) are transmitted or received without using a medium such as optical fibers. A communication system can be constructed by arranging a plurality of communication devices that transmit and receive spatial optical signals.

PTL 1 discloses a communication system that performs multiplex communication using linearly polarized light orthogonal to each other. The system of PTL 1 includes a multiplex data signal transmission device and a multiplex data signal reception device. The multiplex data signal transmission device includes a first light source, a second light source, and a circularly polarized light converter. The first light source outputs first light modulated by a data signal 1. The second light source outputs second light modulated by a data signal 2. The circularly polarized light converter converts the first light into clockwise circularly polarized light, converts the second light into counterclockwise circularly polarized light, and outputs them simultaneously. The multiplex data signal reception device includes a linearly polarized light converter, a first photodetector, and a second photodetector. The linearly polarized light converter converts the clockwise circularly polarized light modulated by the first data signal into first linearly polarized light. The linearly polarized light converter converts the counterclockwise circularly polarized light modulated by the second data signal into second linearly polarized light. The first photodetector detects the first data signal from the first linearly polarized light. The second photodetector detects the second data signal from the second linearly polarized light.

### CITATION LIST

### Patent Literature

PTL 1: JP 2007-318530 A

### SUMMARY OF INVENTION

### Technical Problem

By arranging the system of PTL 1 in a lattice pattern, a communication system that transmits and receives circularly polarized beams rotating in different directions can be constructed. In such a communication system, a plurality of communication devices may be arranged on a straight line. In such a case, there has been a possibility that spatial optical signals transmitted from a plurality of communication devices to be directed in the same direction on the same straight line interfere with each other.

An object of the present disclosure is to provide a communication system capable of suppressing interference between spatial optical signals transmitted from a plurality of communication devices in such a way as to arrive from the same direction and be directed in the same direction.

### Solution to Problem

A communication system according to an aspect of the present disclosure includes a plurality of communication devices, each including a first transmission/reception unit that transmits and receives counterclockwise first circularly polarized optical signals as spatial optical signals and a second transmission/reception unit that transmits and receives clockwise second circularly polarized optical signals as spatial optical signals, in which the plurality of communication devices is arranged in such a way that, among the first transmission/reception units and the second transmission/reception units, transmission/reception parts that transmit and receive circularly polarized optical signals rotating in the same direction face each other between each of the communication devices and another communication device that is a communication counterpart.

### Advantageous Effects of Invention

According to the present disclosure, it is possible to provide a communication system capable of suppressing interference between spatial optical signals transmitted from a plurality of communication devices in such a way as to arrive from the same direction and be directed in the same direction.

### BRIEF DESCRIPTION OF DRAWINGS

FIG. 1 is a conceptual diagram illustrating an example where spatial optical signals (circularly polarized optical signals) are transmitted and received in a communication system according to a first example embodiment.

FIG. 2 is a conceptual diagram illustrating another example where spatial optical signals (circularly polarized optical signals) are transmitted and received in the communication system according to the first example embodiment.

FIG. 3 is a conceptual diagram illustrating still another example where spatial optical signals (circularly polarized optical signals) are transmitted and received in the communication system according to the first example embodiment.

FIG. 4 is a block diagram illustrating an example of a configuration of a communication device according to the first example embodiment.

FIG. 5 is a conceptual diagram illustrating an example of a configuration of a reception device included in the communication device according to the first example embodiment.

FIG. 6 is a conceptual diagram illustrating an example where a first polarizer and a second polarizer included in the reception device of the communication device according to the first example embodiment are arranged.

FIG. 7 is a conceptual diagram for explaining an example where a first circularly polarized optical signal is transmitted and received in the communication device according to the first example embodiment.

FIG. 8 is a conceptual diagram for explaining an example where a second circularly polarized optical signal is transmitted and received in the communication device according to the first example embodiment.

FIG. 9 is a conceptual diagram illustrating an example where a first polarizer and a second polarizer included in the reception device of the communication device according to the first example embodiment are arranged.

FIG. 10 is a conceptual diagram illustrating an example where a circularly polarized optical signal is received by the reception device of the communication device according to the first example embodiment.

FIG. 11 is a block diagram illustrating an example of a configuration of a reception circuit included in the reception device of the communication device according to the first example embodiment.

FIG. 12 is a conceptual diagram illustrating an example of a transmission device included in the communication device according to the first example embodiment.

FIG. 13 is a conceptual diagram illustrating an example of a configuration of the transmission device included in the communication device according to the first example embodiment.

FIG. 14 is a conceptual diagram illustrating an example where a spatial optical signal (circularly polarized optical signal) is transmitted by the transmission device included in the communication device according to the first example embodiment.

FIG. 15 is a block diagram illustrating an example of a configuration of a communication control device included in the communication device according to the first example embodiment.

FIG. 16 is a conceptual diagram illustrating an example of a configuration of a communication device according to the first example embodiment.

FIG. 17 is a conceptual diagram for explaining a communication device in a first configuration example of the communication system according to the first example embodiment.

FIG. 18 is a conceptual diagram for explaining the first configuration example of the communication system according to the first example embodiment.

FIG. 19 is a conceptual diagram for explaining a second configuration example of the communication system according to the first example embodiment.

FIG. 20 is a conceptual diagram for explaining a communication device in a third configuration example of the communication system according to the first example embodiment.

FIG. 21 is a conceptual diagram for explaining the third configuration example of the communication system according to the first example embodiment.

FIG. 22 is a conceptual diagram for explaining an application example of the communication system according to the first example embodiment.

FIG. 23 is a conceptual diagram illustrating an example of a communication system according to a second example embodiment.

FIG. 24 is a block diagram illustrating an example of a hardware configuration for executing control or processing according to each example embodiment.

### EXAMPLE EMBODIMENT

Hereinafter, example embodiments of the present invention will be described with reference to the drawings. However, it should be noted that the example embodiments to be described below are limited to be technically preferable in carrying out the present invention, but the scope of the invention is not limited to the following example embodiments. Note that, in all the drawings used to describe the following example embodiments, the same reference signs are given to the same parts unless there is a particular reason. Furthermore, in the following example embodiments, the description of the same configurations and operations may not be repeated.

In all the drawings used to describe the following example embodiments, a direction of an arrow is an example, and does not limit a direction of light or a signal. In addition, in the drawings, a line indicating a trajectory of light is conceptual, and does not accurately indicate an actual traveling direction or state of light. For example, in the drawings, a change in traveling direction or state of light caused by refraction, reflection, diffraction, diffusion, or the like at an interface between air and a substance may be omitted, or a light flux may be expressed by a single line.

### First Example Embodiment

First, a communication device according to a first example embodiment will be described with reference to the drawings. The communication device according to the present example embodiment performs optical spatial communication in which optical signals propagating in a space are transmitted or received without using a medium such as optical fibers (hereinafter also referred to as spatial optical signals). The communication device according to the present example embodiment performs optical spatial communication by using spatial optical signals including a clockwise circularly polarized optical signal (also referred to as a first circularly polarized optical signal) and a counterclockwise circularly polarized optical signal (a second circularly polarized optical signal).

### Configuration

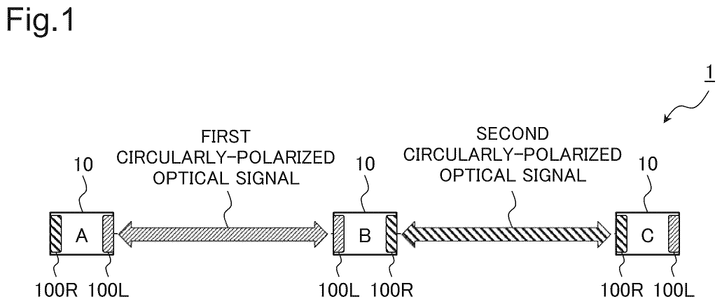

FIG. 1 is a conceptual diagram illustrating an example of a configuration of a communication system 1 according to the present example embodiment. FIG. 1 illustrates an example where spatial optical signals are transmitted and received in the communication system 1. The communication system 1 includes a plurality of communication devices 10. In the example illustrated in FIG. 1, the communication system 1 is constituted by three communication devices 10. In the example of FIG. 1, the three communication devices 10 are arranged on the same straight line. Another adjacent communication device 10 is a counterpart with which each of the plurality of communication devices 10 communicates. The left end communication device 10 and the right end communication device 10 that are adjacent to each other with the center communication device 10 interposed therebetween are not counterparts communicating with each other. Hereinafter, when the plurality of communication devices 10 are distinguished from each other, the left end communication device 10 will be referred to as communication device A, the center communication device 10 will be referred to as communication device B, and the right end communication device 10 will be referred to as communication device C. When matters common to the plurality of communication devices 10 are described, the plurality of communication devices 10 will be referred to as communication device 10.

The communication device 10 transmits and receives a counterclockwise circularly polarized optical signal (also referred to as a first circularly polarized optical signal) and a clockwise circularly polarized optical signal (also referred to as a second circularly polarized optical signal). The communication device 10 includes a first transmission/reception unit 100L and a second transmission/reception unit 100R. The first transmission/reception unit 100L transmits and receives a first circularly polarized optical signal. The second transmission/reception unit 100R transmits and receives a second circularly polarized optical signal. The first transmission/reception unit 100L and the second transmission/reception unit 100R are oriented in different directions.

In the example of FIG. 1, the plurality of communication devices 10 are arranged on the same straight line with the first transmission/reception units 100L or the second transmission/reception units 100R facing each other between the communication devices 10 adjacent to each other. The plurality of communication devices 10 may be arranged in any state other than on the same straight line as long as the first transmission/reception units 100L or the second transmission/reception units 100R face each other between the communication devices 10 adjacent to each other. For example, the plurality of communication devices 10 may be arranged in an annular shape.

In FIG. 1, the left end communication device 10 (communication device A) and the center communication device 10 (communication device B) are arranged with the first transmission/reception units 100L thereof facing each other. The communication device B is a counterpart with which the communication device A communicates. Similarly, the communication device A is a counterpart with which the communication device B communicates. A first circularly polarized optical signal transmitted from the first transmission/reception unit 100L of the communication device A is received by the first transmission/reception unit 100L of the communication device B. Similarly, a first circularly polarized optical signal transmitted from the first transmission/reception unit 100L of the communication device B is received by the first transmission/reception unit 100L of the communication device A.

In FIG. 1, the center communication device 10 (communication device B) and the right end communication device 10 (communication device C) are arranged with the second transmission/reception units 100R thereof facing each other. The communication device C is a counterpart with which the communication device B communicates. Similarly, the communication device B is a counterpart with which the communication device C communicates. A second circularly polarized optical signal transmitted from the second transmission/reception unit 100R of the communication device B is received by the second transmission/reception unit 100R of the communication device C. Similarly, a second circularly polarized optical signal transmitted from the second transmission/reception unit 100R of the communication device C is received by the second transmission/reception unit 100R of the communication device B.

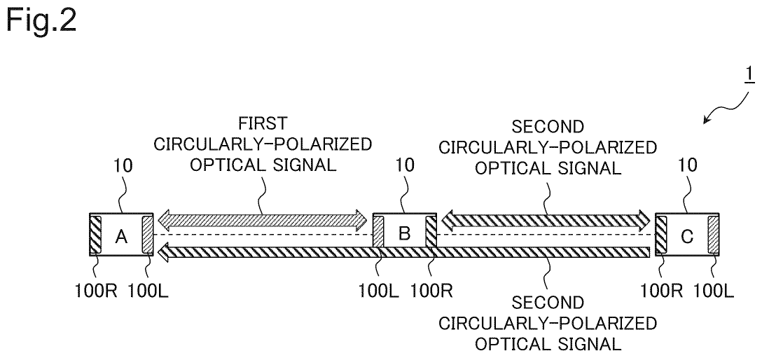

FIG. 2 is a conceptual diagram illustrating another example where spatial optical signals are transmitted and received in the communication system 1. The right end communication device 10 (communication device C) is not a counterpart with which the left end communication device 10 (communication device A) communicates. That is, the communication device A and the communication device C that are adjacent to each other with the center communication device 10 (communication device B) interposed therebetween are not counterparts communicating with each other. In the example of FIG. 2, a second circularly polarized optical signal transmitted from the second transmission/reception unit 100R of the communication device C reaches the first transmission/reception unit 100L of the communication device A. The first transmission/reception unit 100L of the communication device A receives a first circularly polarized optical signal and does not receive a second circularly polarized optical signal. Therefore, the second circularly polarized optical signal transmitted from the second transmission/reception unit 100R of the communication device C is not received by the first transmission/reception unit 100L of the communication device A.

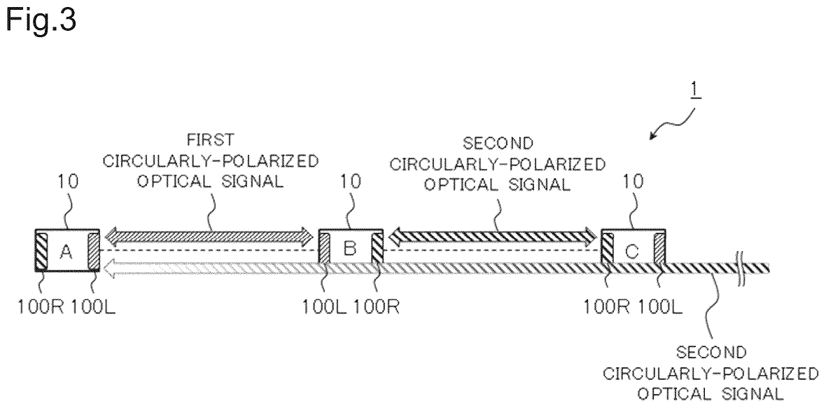

FIG. 3 is a conceptual diagram illustrating still another example where spatial optical signals are transmitted and received in the communication system 1. FIG. 3 illustrates an example in which a spatial optical signal transmitted from a position farther than communication device C reaches the communication device A from the direction of the communication device C. An influence of interference in such a spatial optical signal due to factors such as the presence of the communication device B and the communication device C on the optical path and attenuation until reaching the communication device A can be ignored. That is, the plurality of communication devices 10 constituting the communication system 1 (FIGS. 1 and 2) can selectively receive a spatial optical signal from a communication device 10 that is a communication counterpart, not receiving a spatial optical signal of a spatial optical signal (first circularly polarized optical signal/second circularly polarized optical signal) from a communication device 10 that is not a communication counterpart.

In optical spatial communication using non-polarized light, there is a possibility that a spatial optical signal transmitted from a position farther than a communication counterpart is interfered with in the situation as illustrated in FIG. 2. In addition, even in optical spatial communication using circularly polarized light, if the rotation directions of the circularly polarized beams of light are identical, there is a possibility that a spatial optical signal transmitted from a position farther than a communication counterpart is interfered with in the situation as illustrated in FIG. 2. According to the method of the present example embodiment, in communication with two or more communication counterparts (other communication devices 10) adjacent to the communication device 10, the interference in a spatial optical signal transmitted from a distant position can be suppressed by using circularly polarized beams of light in different rotation directions.

### (Communication Device)

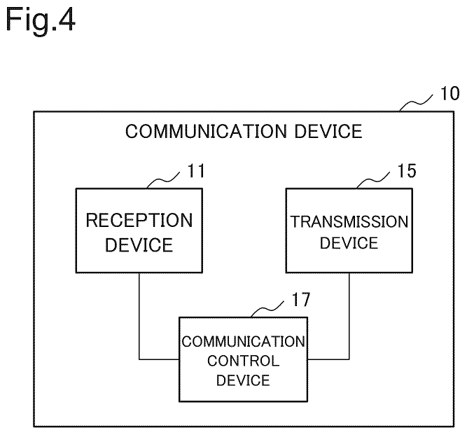

Next, an example of the communication device 10 constituting the communication system 1 will be described with reference to the drawings. FIG. 4 is a block diagram illustrating an example of a configuration of the communication device 10. The communication device 10 includes a reception device 11, a transmission device 15, and a communication control device 17. Hereinafter, the reception device 11, the transmission device 15, and the communication control device 17 will be individually described.

### [Reception Device]

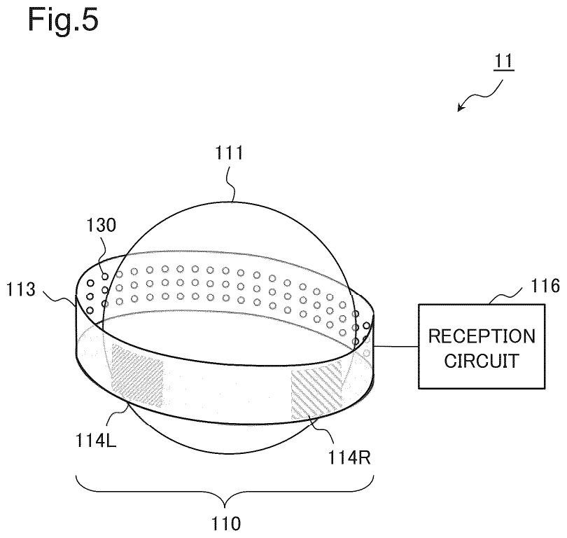

FIG. 5 is a conceptual diagram illustrating an example of a configuration of the reception device 11. The reception device 11 includes a ball lens 111, a light receiving unit 113, a first polarizer 114L, a second polarizer 114R, and a reception circuit 116. The ball lens 111, the light receiving unit 113, the first polarizer 114L, and the second polarizer 114R constitute a light receiver 110. FIG. 5 is a perspective view of the light receiver 110 viewed downward and obliquely from above the circular ring formed by the light receiving unit 113. FIG. 5 is an example of the configuration of the reception device 11, and does not limit the configuration for implementing the reception device 11. Depending on the environment in which the communication device 10 is disposed, the light receiver 110 is preferably mounted inside a housing or the like including a cover that is transparent to spatial optical signals. In the present example embodiment, the ball lens 111 is used as an example, but the lens used for receiving spatial optical signals is not limited to the ball lens 111. For example, a lens such as a convex lens or a cylindrical lens capable of condensing a spatial optical signal may be arranged for each direction from which the spatial optical signals arrive.

The ball lens 111 is a spherical lens. The ball lens 111 is an optical element that condenses a spatial optical signal arriving from the outside. The ball lens 111 is spherical when viewed at any angle. The ball lens 111 condenses a spatial optical signal incident thereon. Light (also referred to as an optical signal) derived from the spatial optical signal condensed by the ball lens 111 is condensed toward a condensing region. Since the ball lens 111 has a spherical shape, a spatial optical signal arriving from any direction is condensed in the condensing region around the ball lens 111. That is, the ball lens 111 exhibits similar light condensing performances for spatial optical signals arriving from any directions.

For example, the ball lens 111 can be made of a material such as glass, crystal, or resin (plastic). In a case where a spatial optical signal in the visible region is received, the material that transmits/refracts light in the visible region can be applied to the ball lens 111. The material that transmits/refracts light in the visible region is, for example, glass, crystal, resin, or the like. For example, optical glass such as crown glass or flint glass can be applied to the ball lens 111. For example, crown glass such as Boron Kron (BK) can be applied to the ball lens 111. For example, flint glass such as Lanthanum Schwerflint (LaSF) can be applied to the ball lens 111. For example, quartz glass can be applied to the ball lens 111. For example, crystal such as sapphire can be applied to the ball lens 111. For example, transparent resin such as acryl can be applied to the ball lens 111. In a case where the spatial optical signal is light in a near-infrared region (hereinafter also referred to as near-infrared light), a material capable of transmitting near-infrared light is used for the ball lens 111. For example, in a case where a spatial optical signal in a near-infrared region of about 1.5 micrometers (μm), a material such as silicon, which transmits light in the near-infrared region, can be applied to the ball lens 111. In a case where the spatial optical signal is light in an infrared region (hereinafter also referred to as infrared light), a material capable of transmitting infrared light is used for the ball lens 111. For example, in a case where the spatial optical signal is infrared light, a silicon, germanium, or chalcogenide material can be applied to the ball lens 111. The material of the ball lens 111 is not limited as long as it is capable of transmitting/refracting light in the wavelength region of the spatial optical signal. The material of the ball lens 111 may be appropriately selected according to the desired refractive index and application.

The light receiving unit 113 is constituted by a plurality of light receiving elements 130. The plurality of light receiving elements 130 are arranged in an annular shape along the circumferential direction of the ball lens 111. For example, the plurality of light receiving elements 130 are arranged in a lattice pattern so as to surround the circumference of the ball lens 111 along the circumferential direction of the ball lens 111. The number of light receiving elements 130 constituting the light receiving unit 113 is not limited. The light receiving unit 113 is disposed after the ball lens 111.

The light receiving element 130 includes a light receiving portion (not illustrated) that receives an optical signal derived from a spatial optical signal to be received on a light receiving surface thereof. Each of the plurality of light receiving elements 130 is disposed in such a way that the light receiving surface thereof faces a light emitting surface of the ball lens 111. The light receiving portions of the plurality of light receiving elements 130 are arranged to match the condensing region of the ball lens 111. The light receiving element 130 is sensitive to a spatial optical signal used for communication. The plurality of light receiving elements 130 are arranged with the light receiving portions thereof facing the center of the ball lens 111. The optical signal condensed at the position of the light receiving unit 113 by the ball lens 111 is received by the light receiving portion of one of the light receiving elements 130. The plurality of light receiving elements 130 may be grouped for every several light receiving elements 130. For example, some light receiving elements 130 are associated with the first polarizer 114L or the second polarizer 114R. The light receiving elements 130 associated with the first polarizer 114L or the second polarizer 114R are grouped for each first polarizer 114L or each second polarizer 114R. An optical signal received by each of the plurality of light receiving elements 130 is sorted by group and distributed to one of a plurality of amplifiers (to be described below) included in the reception circuit 116. For example, the optical signal received by each of the plurality of light receiving elements 130 is amplified by an amplifier and then processed by group. For example, the optical signal received by each of the plurality of light receiving elements 130 may be processed for each light receiving element 130.

The light receiving element 130 is sensitive to light in a wavelength region of a spatial optical signal to be received. For example, the light receiving element 130 is sensitive to light in the visible region. For example, the light receiving element 130 is sensitive to light in the infrared region. The light receiving element 130 is sensitive to light having a wavelength, for example, in the 1.5 micrometers (μm) band. The wavelength band of the light received by the light receiving element 130 can be set in accordance with a wavelength of a spatial optical signal transmitted from a transmission device (not illustrated). The wavelength band of the light received by the light receiving element 130 may be set to, for example, a 0.8 μm band, a 1.55 μm band, or a 2.2 μm band. Alternatively, the wavelength band of the light received by the light receiving element 130 may be, for example, a 0.8 to 1.0 μm band. The shorter the wavelength band, the smaller the absorption by moisture in the atmosphere, which is advantageous for optical spatial communication during rainfall. In addition, if saturated with intense sunlight, the light receiving element 130 is not capable of reading an optical signal derived from a spatial optical signal. Therefore, a color filter that selectively allows light in the wavelength band of the spatial optical signal to pass therethrough and blocks light in the other wavelength bands may be installed before the light receiving element 130. For example, in a case where a cover surrounding the light receiver 110 is installed, a color filter may be configured in a part of the cover in accordance with the direction from which the spatial optical signals arrive.

For example, the light receiving element 130 can be achieved by an element such as a photodiode or a phototransistor. For example, the light receiving element 130 is achieved by an avalanche photodiode. The light receiving element 130 achieved by the avalanche photodiode is capable of supporting high-speed communication. Note that the light receiving element 130 may be achieved by an element other than the photodiode, the phototransistor, or the avalanche photodiode as long as it is capable of converting an optical signal into an electric signal. In order to improve the communication speed, the light receiving portion of the light receiving element 130 is preferably as small as possible. For example, the light receiving portion of the light receiving element 130 has a square light receiving surface having a side of about 5 millimeters (mm). For example, the light receiving portion of the light receiving element 130 has a circular light receiving surface having a diameter of about 0.1 to 0.3 mm. The size and shape of the light receiving portion of the light receiving element 130 may be selected according to the wavelength band of the spatial optical signal, the communication speed, and the like.

The light receiving element 130 converts the received optical signal into an electric signal. The light receiving element 130 outputs the converted electric signal to the reception circuit 116. Although only one line (path) is illustrated between the light receiving unit 113 and the reception circuit 116 in FIG. 5, this does not indicate that the light receiving unit 113 and the reception circuit 116 are connected to each other by one path. For example, the light receiving unit 113 and the reception circuit 116 are connected to each other by a path for each of the plurality of light receiving elements 130. For example, each of the light receiving elements 130 constituting the light receiving unit 113 may be individually connected to the reception circuit 116. For example, some of the light receiving elements 130 constituting the light receiving unit 113 may be grouped in association with the first polarizer 114L or the second polarizer 114R, and each of the grouped light receiving elements 130 may be connected to the reception circuit 116.

The first polarizer 114L and the second polarizer 114R are arranged in association with one of the plurality of light receiving elements 130 constituting the light receiving unit 113. The first polarizer 114L converts a counterclockwise circularly polarized optical signal (first circularly polarized optical signal) into linearly polarized light. The second polarizer 114R converts a clockwise circularly polarized optical signal (second circularly polarized optical signal) into linearly polarized light.

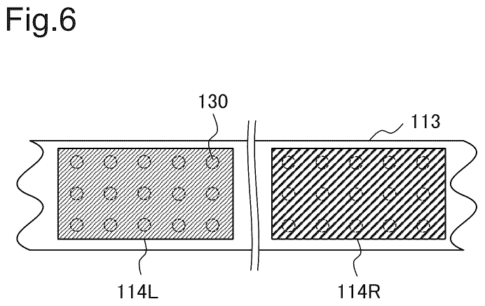

FIG. 6 is a conceptual diagram illustrating an example in which the first polarizer 114L and the second polarizer 114R are arranged in association with the plurality of light receiving elements 130 constituting the light receiving unit 113. The first polarizer 114L converts a counterclockwise circularly polarized optical signal (first circularly polarized optical signal) into linearly polarized light. The first polarizer 114L is disposed in association with the light receiving element 130 that receives a first circularly polarized optical signal transmitted from a communication device 10 that is a communication counterpart. For example, the first polarizer 114L is disposed along the light receiving surfaces of the plurality of light receiving elements 130. In the example of FIG. 6, the first polarizer 114L is disposed along the light receiving surfaces of the plurality of light receiving elements 130 arranged in a lattice pattern of 3 rows×5 columns. The first circularly polarized optical signal having passed through the first polarizer 114L is converted into linearly polarized light to be received, and is received by the light receiving element 130 associated with the first polarizer 114L.

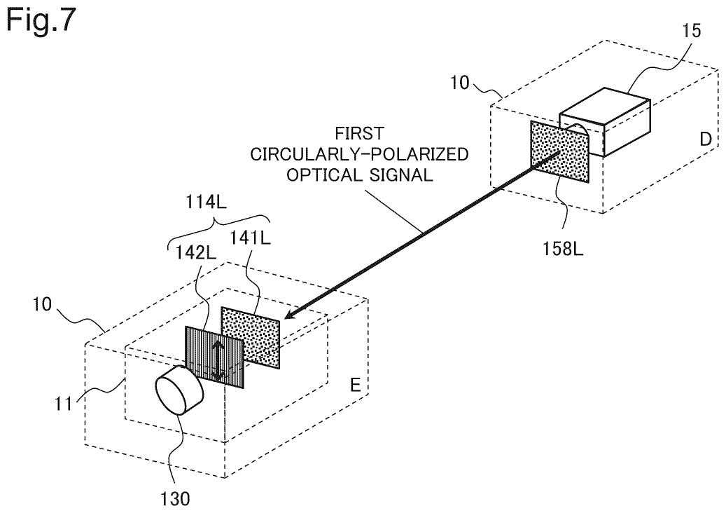

FIG. 7 is a conceptual diagram for explaining an example in which a first circularly polarized optical signal is transmitted and received. FIG. 7 conceptually illustrates the principle of transmission and reception of the first circularly polarized optical signal, and does not accurately illustrate an actual configuration. In the example illustrated in FIG. 7, a first circularly polarized optical signal is transmitted as a spatial optical signal from an upper right communication device 10 to a lower left communication device 10. The upper right communication device 10 will be referred to as communication device D, and the lower left communication device 10 will be referred to as communication device E. The first circular polarizer 158L is a ¼ wavelength plate that converts linearly polarized light into a counterclockwise circularly polarized optical signal (first circularly polarized optical signal). In the present example embodiment, the transmission device 15 includes a light source (to be described below) that emits linearly polarized light whose vibration direction is aligned with a certain direction. In that case, since projection light emitted from the transmission device 15 is linearly polarized light whose vibration direction is aligned with a certain direction, it is not necessary to arrange a linearly polarizing plate before the first circular polarizer 158L (¼ wavelength plate). When the vibration direction of the projection light emitted from the transmission device 15 is not aligned with a certain direction, a linearly polarizing plate may be arranged before the first circular polarizer 158L (¼ wavelength plate). In the example of FIG. 7, the linearly polarized light transmitted from the transmission device 15 of the communication device D is converted into a first circularly polarized optical signal by passing through the first circular polarizer 158L. The first circularly polarized optical signal transmitted from the transmission device 15 of the communication device D reaches the communication device E.

In the example of FIG. 7, the first polarizer 114L has a structure in which a first circularly polarizing plate 141L and a first linearly polarizing plate 142L are combined. In practice, the first circularly polarizing plate 141L and the first linearly polarizing plate 142L are stacked. The first circularly polarizing plate 141L of the communication device E is oriented toward the communication device D that is a communication counterpart. The first linearly polarizing plate 142L of the communication device E is directed toward the light receiving surface of the light receiving element 130 included in the communication device E. The first circularly polarizing plate 141L is a ¼ wavelength plate that converts a counterclockwise circularly polarized optical signal (first circularly polarized optical signal) into linearly polarized light. The first circularly polarizing plate 141L converts a first circularly polarized optical signal into linearly polarized light. The first linearly polarizing plate 142L is a linearly polarizing plate that allows linearly polarized light to be received to pass therethrough. The conversion of the first circularly polarized optical signal into the linearly polarized light is determined by the axial direction of the first circularly polarizing plate 141L (¼ wavelength plate). The first circularly polarizing plate 141L (¼ wavelength plate) is disposed in such a way that the delay axis is-45 degrees with respect to the absorption axis of the first linearly polarizing plate 142L. In the example of FIG. 7, the first linearly polarizing plate 142L of the communication device E allows linearly polarized light that coincides with the vibration direction of projection light emitted from the transmission device 15 of the communication device D that is a communication counterpart to pass therethrough. The first circularly polarized optical signal is converted into linearly polarized light by passing through the first circularly polarizing plate 141L. The linearly polarized light to be received passes through the first linearly polarizing plate 142L and reaches the light receiving portion of the light receiving element 130. The linearly polarized light (optical signal) reaching the light receiving portion of the light receiving element 130 is received by the light receiving element 130.

The second polarizer 114R converts a clockwise circularly polarized optical signal (second circularly polarized optical signal) into linearly polarized light. The second polarizer 114R is disposed in association with the light receiving element 130 that receives a second circularly polarized optical signal transmitted from a communication device 10 that is a communication counterpart. For example, the second polarizer 114R is disposed along the light receiving surfaces of the plurality of light receiving elements 130. In the example of FIG. 6, the second polarizer 114R is disposed along the light receiving surfaces of the plurality of light receiving elements 130 arranged in a lattice pattern of 3 rows×5 columns. The second circularly polarized optical signal having passed through the second polarizer 114R is converted into linearly polarized light to be received, and is received by the light receiving element 130 associated with the second polarizer 114R.

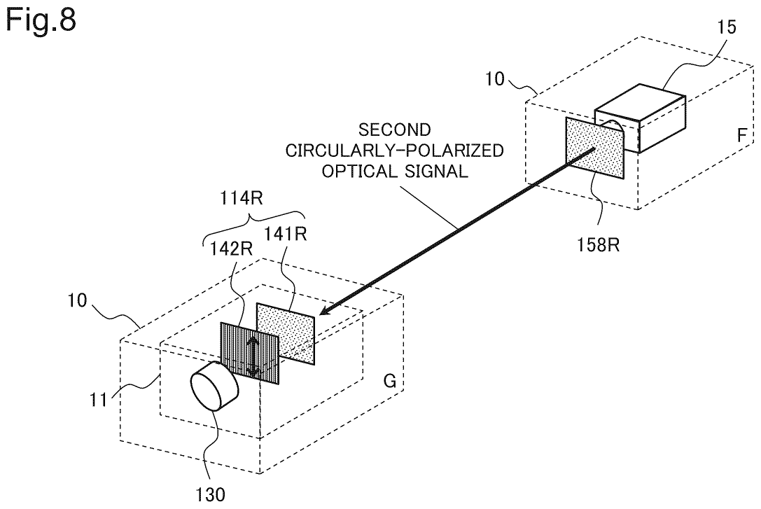

FIG. 8 is a conceptual diagram for explaining an example in which a second circularly polarized optical signal is transmitted and received. FIG. 8 conceptually illustrates the principle of transmission and reception of the second circularly polarized optical signal, and does not accurately illustrate an actual configuration. In the example illustrated in FIG. 8, a second circularly polarized optical signal is transmitted as a spatial optical signal from an upper right communication device 10 to a lower left communication device 10. The upper right communication device 10 will be referred to as communication device F, and the lower left communication device 10 will be referred to as communication device G. The second circular polarizer 158R is a ¼ wavelength plate that converts linearly polarized light into a clockwise circularly polarized optical signal (second circularly polarized optical signal). In the present example embodiment, the transmission device 15 includes a light source (to be described below) that emits linearly polarized light whose vibration direction is aligned with a certain direction. In that case, since projection light emitted from the transmission device 15 is linearly polarized light whose vibration direction is aligned with a certain direction, it is not necessary to arrange a linearly polarizing plate before the second circular polarizer 158R (¼ wavelength plate). When the vibration direction of the projection light emitted from the transmission device 15 is not aligned with a certain direction, a linearly polarizing plate may be arranged before the second circular polarizer 158R (¼ wavelength plate). In the example of FIG. 8, the linearly polarized light transmitted from the transmission device 15 of the communication device F is converted into a second circularly polarized optical signal by passing through the second circular polarizer 158R. The second circularly polarized optical signal transmitted from the transmission device 15 of the communication device F reaches the communication device G.

In the example of FIG. 8, the second polarizer 114R has a structure in which a second circularly polarizing plate 141R and a second linearly polarizing plate 142R are combined. Actually, the second circularly polarizing plate 141R and the second linearly polarizing plate 142R are stacked. The second circularly polarizing plate 141R of the communication device G is directed toward the communication device F that is a communication counterpart. The second linearly polarizing plate 142R of the communication device G is directed toward the light receiving surface of the light receiving element 130 included in the communication device G. The second circularly polarizing plate 141R is a ¼ wavelength plate that converts a clockwise circularly polarized optical signal (second circularly polarized optical signal) into linearly polarized light. The second circularly polarizing plate 141R converts a second circularly polarized optical signal into linearly polarized light. The second linearly polarizing plate 142R is a linearly polarizing plate that allows linearly polarized light to be received to pass therethrough. The conversion of the second circularly polarized optical signal into the linearly polarized light is determined by the axial direction of the second circularly polarizing plate 141R (¼ wavelength plate). The second circularly polarizing plate 141R (¼ wavelength plate) is disposed in such a way that the delay axis is +45 degrees with respect to the absorption axis of the second linearly polarizing plate 142R. In the example of FIG. 8, the second linearly polarizing plate 142R of the communication device G allows linearly polarized light that coincides with the vibration direction of projection light emitted from the transmission device 15 of the communication device F that is a communication counterpart to pass therethrough. The second circularly polarized optical signal is converted into linearly polarized light by passing through the second circularly polarizing plate 141R. The linearly polarized light to be received passes through the second linearly polarizing plate 142R and reaches the light receiving portion of the light receiving element 130. The linearly polarized light (optical signal) reaching the light receiving portion of the light receiving element 130 is received by the light receiving element 130.

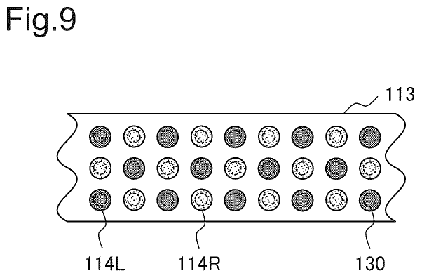

FIG. 9 is a conceptual diagram illustrating an example in which the first polarizer 114L and the second polarizer 114R are arranged for the light receiving portion of each of the plurality of light receiving elements 130 constituting the light receiving unit 113. The first polarizer 114L is disposed on the light receiving portion of the light receiving element 130 that receives a first circularly polarized optical signal transmitted from the communication device 10 that is a communication counterpart. The second polarizer 114R is disposed on the light receiving portion of the light receiving element 130 that receives a second circularly polarized optical signal transmitted from the communication device 10 that is a communication counterpart. The first circularly polarized optical signal having passed through the first polarizer 114L is converted into linearly polarized light to be received, and is received by the light receiving element 130 for which the first polarizer 114L is disposed. The second circularly polarized optical signal having passed through the second polarizer 114R is converted into linearly polarized light to be received, and is received by the light receiving element 130 for which the second polarizer 114R is disposed. In the example of FIG. 9, the first polarizers 114L and the second polarizers 114R are alternately arranged with respect to the plurality of light receiving elements 130 arranged in a lattice pattern. The arrangement of the first polarizer 114L and the second polarizer 114R can be set in any manner. For example, the number (density) of light receiving elements 130 arranged per unit area may be increased to improve the light receiving efficiency.

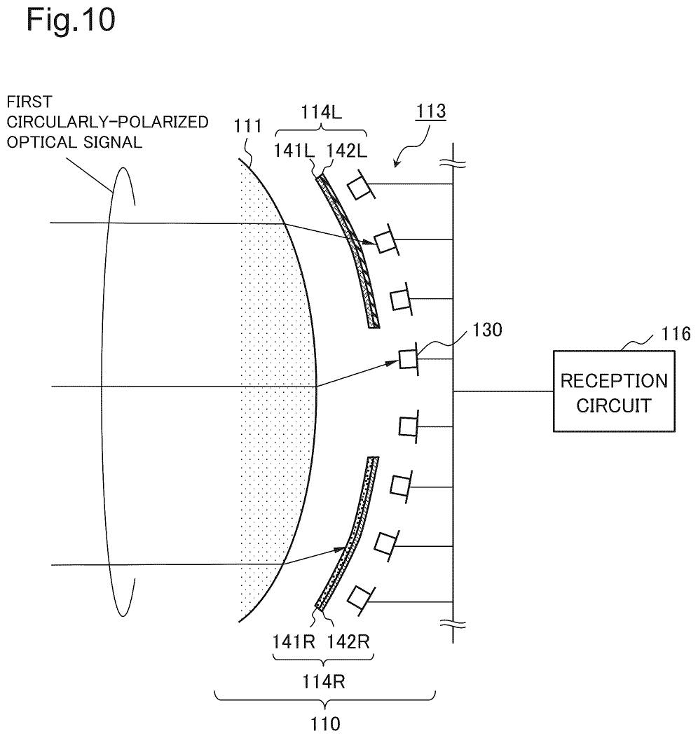

FIG. 10 is a conceptual diagram for explaining reception of a spatial optical signal by the reception device 11. FIG. 10 is an enlarged view of a portion where the light receiver 110 is positioned. The first polarizer 114L and the second polarizer 114R are disposed before the plurality of light receiving elements 130. The positional relationship and the interval between the first polarizer 114L or the second polarizer 114R and the plurality of light receiving elements 130 are not particularly limited. The first polarizer 114L has a configuration in which the first circularly polarizing plate 141L and a first linearly polarizing plate 142L are combined. The second polarizer 114R has a configuration in which the second circularly polarizing plate 141R and the second linearly polarizing plate 142R are combined. In the example of FIG. 10, a light receiving element 130 for which neither the first polarizer 114L nor the second polarizer 114R is disposed is also included.

In the example of FIG. 10, a first circularly polarized optical signal arrives as a spatial optical signal. The first circularly polarized optical signal that has arrived at the first polarizer 114L is converted into linearly polarized light to be received, and reaches the light receiving element 130 disposed after the first polarizer 114L. The linearly polarized light (optical signal) incident on the light receiving portion of the light receiving element 130 is received by the light receiving element 130. On the other hand, the first circularly polarized optical signal that has arrived at the second polarizer 114R does not pass through the second polarizer 114R. Therefore, the light receiving element 130 disposed after the second polarizer 114R does not receive an optical signal corresponding to the first circularly polarized optical signal. In addition, the first circularly polarized optical signal directly arrives at the light receiving element 130 for which neither the first polarizer 114L nor the second polarizer 114R is disposed. The first circularly polarized optical signal (optical signal) that has directly arrived at the light receiving portion of the light receiving element 130 is received by the light receiving element as it is.

When a second circularly polarized optical signal arrives as a spatial optical signal, the second circularly polarized optical signal that has arrived at the first polarizer 114L does not pass through the first polarizer 114L. Therefore, the light receiving element 130 disposed after the first polarizer 114L does not receive an optical signal corresponding to the second circularly polarized optical signal. On the other hand, the second circularly polarized optical signal that has arrived at the second polarizer 114R is converted into linearly polarized light to be received, and reaches the light receiving element 130 disposed after the second polarizer 114R. The linearly polarized light (optical signal) incident on the light receiving portion of the light receiving element 130 is received by the light receiving element 130. In addition, the second circularly polarized optical signal directly arrives at the light receiving element 130 for which neither the first polarizer 114L nor the second polarizer 114R is disposed. The second circularly polarized optical signal (optical signal) that has directly arrived at the light receiving portion of the light receiving element 130 is received by the light receiving element as it is.

### [Reception Circuit]

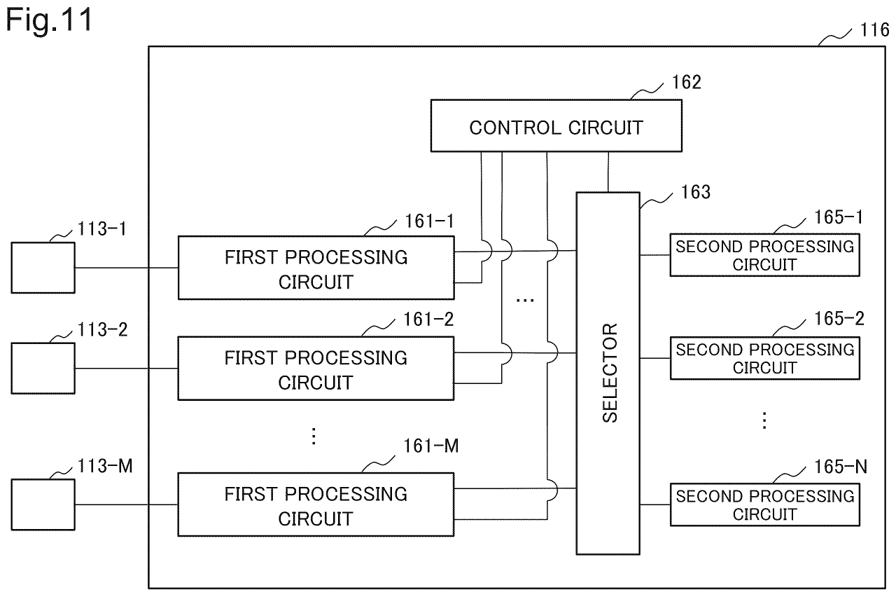

Next, an example of a detailed configuration of the reception circuit 116 included in the reception device 11 will be described with reference to the drawings. FIG. 11 is a block diagram illustrating an example of a configuration of the reception circuit 116. In the example of FIG. 11, the number of light receiving elements 130 is M (M is a natural number). Note that FIG. 11 is an example of the configuration of the reception circuit 116, and does not limit the configuration of the reception circuit 116.

The reception circuit 116 includes a plurality of first processing circuits 161-1 to 161-M, a control circuit 162, a selector 163, and a plurality of second processing circuits 165-1 to 165-N (M and N are natural numbers.). The first processing circuit 161 is associated with one of the plurality of light receiving elements 130-1 to 130-M. The first processing circuit 161 may be configured for each group of a plurality of light receiving elements 130 included in the plurality of light receiving elements 130-1 to 130-M.

For example, the first processing circuit 161 includes a high pass filter (not illustrated). The high pass filter acquires signals from the light receiving element 130. The high pass filter selectively allows a signal of a high frequency component corresponding to the wavelength band of the spatial optical signal, among the acquired signals, to pass therethrough. The high pass filter blocks a signal derived from ambient light such as sunlight. For example, instead of the high pass filter, a band pass filter that selectively allows a signal in the wavelength band of the spatial optical signal to pass therethrough may be included. When the light receiving element 130 is saturated with intense sunlight, an optical signal cannot be read. Therefore, a color filter that selectively allows light in the wavelength band of the spatial optical signal to pass therethrough may be installed before the light receiving portion of the light receiving element 130.

For example, the first processing circuit 161 includes an amplifier (not illustrated). The amplifier acquires the signals output from the high pass filter. The amplifier amplifies the acquired signals. The signal amplification factor of the amplifier is not particularly limited.

For example, the first processing circuit 161 includes an output monitor (not illustrated). The output monitor monitors an output value of the amplifier. The output monitor outputs signals exceeding a predetermined output value among the signals amplified by the amplifier to the selector 163. Among the signals output to the selector 163, a signal to be received is allocated to one of the plurality of second processing circuits 165-1 to 165-N according to the control of the control circuit 162. The signal to be received is a spatial optical signal from a communication device (not illustrated) to communicate with. A signal from the light receiving element 130 that is not used for receiving a spatial optical signal is not output to the second processing circuit 165.

For example, the first processing circuit 161 may include an integrator (not illustrated) as an output monitor (not illustrated). The integrator acquires the signals output from the high pass filter. The integrator integrates the acquired signals. The integrator outputs the integrated signals to the control circuit 162. The integrator is disposed to measure an intensity of a spatial optical signal received by the light receiving element 130. Since the intensity of the spatial optical signal received in a state where the beam diameter is not narrowed is weak as compared with that in a case where the beam diameter is narrowed, it is difficult to measure a voltage of the signal amplified only by the amplifier. By using the integrator, the voltage of the signal can be increased to a level at which the voltage can be measured by integrating the signal, for example, in a period of several milliseconds to several tens of milliseconds.

The control circuit 162 acquires a signal output from each of the plurality of first processing circuits 161-1 to 161-M. In other words, the control circuit 162 acquires a signal derived from an optical signal received by each of the plurality of light receiving elements 130-1 to 130-M. For example, the control circuit 162 compares read values of the signals from the plurality of light receiving elements 130 adjacent to each other. The control circuit 162 selects a light receiving element 130 having the largest signal intensity according to the comparison result. The control circuit 162 controls the selector 163 in such a way as to assign the signal derived from the selected light receiving element 130 to one of the plurality of second processing circuits 165-1 to 165-N. For example, the control circuit 162 controls the selector 163 in such a way that signals from a plurality of light receiving elements 130 constituting a group are distributed to the same second processing circuit 165.

In a case where the position of the communication counterpart is specified in advance, the processing of estimating a direction from which a spatial optical signal arrives is not performed, and signals output from the light receiving elements 130-1 to 130-M may be output to a preset one of the second processing circuits 165. On the other hand, in a case where the position of the communication counterpart is not specified in advance, a second processing circuit 165 may be selected as a destination to which signals are output from the light receiving elements 130-1 to 130-M. For example, as the control circuit 162 selects a light receiving element 130, a direction from which a spatial optical signal arrives can be estimated. That is, the selecting of the light receiving element 130 by the control circuit 162 corresponds to specifying a communication device as a source from which the spatial optical signal is transmitted. In addition, the allocating of the signal from the light receiving element 130 selected by the control circuit 162 to one of the plurality of second processing circuits corresponds to associating the specified communication counterpart with the light receiving element 130 that receives the spatial optical signal from the communication counterpart. That is, based on the optical signals received by the plurality of light receiving elements 130-1 to 130-M, the control circuit 162 can specify communication devices as sources from which the optical signals (spatial optical signals) are transmitted.

For example, the control circuit 162 may be configured to specify a direction from which a spatial optical signal arrives by performing a primary scan with coarse accuracy, and specify an accurate position of a communication counterpart by performing a secondary scan with fine accuracy with respect to the specified direction. When communication with the communication counterpart becomes possible, the accurate position of the communication counterpart can be determined by exchanging signals with the communication counterpart.

The signal amplified by the amplifier included in each of the plurality of first processing circuits 161-1 to 161-M is input to the selector 163. The selector 163 outputs a signal to be received among the input signals to one of the plurality of second processing circuits 165-1 to 165-N according to the control of the control circuit 162. A signal that is not to be received is not output from the selector 163.

A signal from one of the plurality of light receiving elements 130-1 to 130-N assigned by the control circuit 162 is input to each of the plurality of second processing circuits 165-1 to 165-N. For example, signals from a plurality of light receiving elements 130 that have received optical signals based on a circularly polarized optical signal (spatial optical signals) transmitted from the same communication counterpart are input to each of the plurality of second processing circuits 165-1 to 165-N. For example, signals from a plurality of light receiving elements 130 constituting a group are input to each of the plurality of second processing circuits 165-1 to 165-N. Each of the plurality of second processing circuits 165-1 to 165-N decodes the input signal. Each of the plurality of second processing circuits 165-1 to 165-N may be configured to apply certain signal processing to the decoded signal. Each of the plurality of second processing circuits 165-1 to 165-N may be configured to output the decoded signal to an external signal processing device or the like (not illustrated).

The selector 163 selects a signal derived from the light receiving element 130 selected by the control circuit 162, thereby allocating one second processing circuit 165 to one communication counterpart. That is, the control circuit 162 allocates each of the signals derived from the spatial optical signals from the plurality of communication counterparts, which are received by the plurality of light receiving elements 130-1 to 130-M, to one of the plurality of second processing circuits 165-1 to 165-N. As a result, the reception device 11 can simultaneously read signals derived from spatial optical signals from a plurality of communication counterparts in individual channels. For example, in order to simultaneously communicate with a plurality of communication counterparts, spatial optical signals from the plurality of communication counterparts may be read in time division in a single channel. In the method according to the present example embodiment, since spatial optical signals from a plurality of communication counterparts are simultaneously read in a plurality of channels, a transmission speed is faster than that in a case where a single channel is used.

### [Transmission Device]

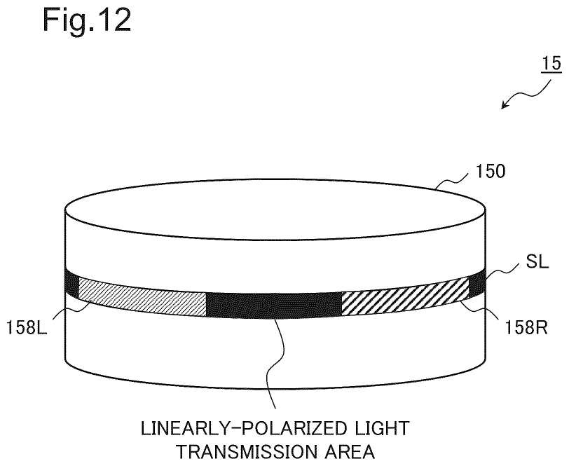

FIG. 12 is a conceptual diagram illustrating an example of a configuration of the transmission device 15. FIG. 12 illustrates an example in which the projection function of the transmission device 15 is mounted inside a cylindrical housing 150. A slit SL for projecting projection light (spatial optical signal) is opened on a side surface of the housing 150. The first circular polarizer 158L and the second circular polarizer 158R are arranged in the slit SL according to a rotation direction of circularly polarized light (spatial optical signal) transmitted from a communication device 10 that is a communication counterpart. In the example of FIG. 12, the slit SL includes a portion (also referred to as a linearly polarized light receiving region) where the first circular polarizer 158L and the second circular polarizer 158R are not disposed. In the present example embodiment, the transmission device 15 includes a light source (to be described below) that emits linearly polarized light whose vibration direction is aligned with a certain direction.

The first circular polarizer 158L is a ¼ wavelength plate that converts linearly polarized light into a counterclockwise circularly polarized optical signal (first circularly polarized optical signal). When the vibration direction of the projection light emitted from the transmission device 15 is not aligned with a certain direction, a linearly polarizing plate that allows linearly polarized light to be received by a communication device 10 that is a communication counterpart to pass therethrough may be disposed before the first circular polarizer 158L (¼ wavelength plate). The first circular polarizer 158L (¼ wavelength plate) is disposed in such a way that the delay axis is +45 degrees with respect to the absorption axis of the linearly polarized light.

The second circular polarizer 158R is a ¼ wavelength plate that converts linearly polarized light into a clockwise circularly polarized optical signal (second circularly polarized optical signal). When the vibration direction of the projection light emitted from the transmission device 15 is not aligned with a certain direction, a linearly polarizing plate that allows linearly polarized light to be received by a communication device 10 that is a communication counterpart to pass therethrough may be disposed before the second circular polarizer 158R (¼ wavelength plate). The second circular polarizer 158R (¼ wavelength plate) is disposed in such a way that the delay axis is-45 degrees with respect to the absorption axis of the linearly polarized light.

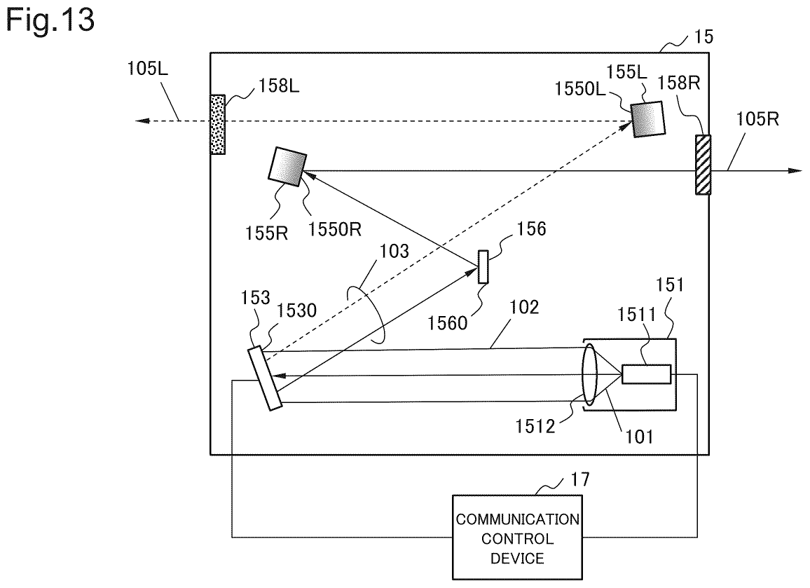

FIG. 13 is a conceptual diagram illustrating an example of a configuration of the transmission device 15. The transmission device 15 includes a light source 151, a spatial light modulator 153, a first curved mirror 155L, a second curved mirror 155R, and a folding mirror 156. The light source 151 and the spatial light modulator 153 are connected to the communication control device 17. FIG. 13 is a side view of an internal configuration of the transmission device 15 as viewed in the lateral direction. FIG. 13 is conceptual, and does not accurately indicate a positional relationship between the components, a traveling direction of light, etc. Note that FIG. 13 is an example, and does not limit the configuration of the transmission device 15.

The light source 151 includes an emitter 1511 and a lens 1512. The emitter 1511 emits laser light 101 in a predetermined wavelength band according to the control of the communication control device 17. The laser light 101 is linearly polarized light whose vibration direction is along a certain direction. The wavelength of the laser light 101 emitted from the light source 151 is not particularly limited, and may be selected according to the application. For example, the emitter 1511 emits laser light 101 in the visible or infrared wavelength band. For example, near-infrared light in the range of 800 to 900 nanometers (nm) can raise the laser class, thereby improving sensitivity by about a one-digit number as compared with the other wavelength bands. For example, a high-output laser light source can be used for infrared light in a wavelength band of 1.55 micrometers (μm). As an infrared laser light source in a wavelength band of 1.55 μm, an aluminum gallium arsenide phosphorus (AlGaAsP)-based laser light source, an indium gallium arsenide (InGaAs)-based laser light source, or the like can be used. The longer the wavelength of the laser light 101 is, the larger the diffraction angle can be set and the higher the energy can be set. Although FIG. 13 illustrates an example in which the transmission device 15 includes one light source 151, the transmission device 15 may include a plurality of light sources 151. For example, the transmission device 15 may include a light source 151 for each communication counterpart. When the transmission device 15 includes a light source 151 for each communication counterpart, a timing at which a spatial optical signal is transmitted can be set for each communication counterpart.

The lens 1512 condenses the laser light 101 emitted from the emitter 1511 in accordance with a size of a modulation part 1530 of the spatial light modulator 153. The laser light 101 emitted from the emitter 1511 is condensed by the lens 1512 and emitted from the light source 151. Light 102 emitted from the light source 151 travels toward the modulation part 1530 of the spatial light modulator 153.

The spatial light modulator 153 includes a modulation part 1530 irradiated with the light 102. The modulation part 1530 of the spatial light modulator 153 is irradiated with the light 102 emitted from the light source 151. In the modulation part 1530 of the spatial light modulator 153, a pattern according to an image displayed by projection light is set according to the control of the communication control device 17. The light 102 incident on the modulation part 1530 of the spatial light modulator 153 is modulated according to the pattern set in the modulation part 1530 of the spatial light modulator 153. Modulated light 103 modulated by the modulation part 1530 of the spatial light modulator 153 travels toward a reflective surface 1550L of the first curved mirror 155L and a reflective surface 1560 of the folding mirror 156.

For example, the spatial light modulator 153 is achieved by a spatial light modulator using ferroelectric liquid crystal, homogeneous liquid crystal, vertical alignment liquid crystal, or the like. For example, the spatial light modulator 153 can be achieved by liquid crystal on silicon (LCOS). Alternatively, the spatial light modulator 153 may be achieved by a micro electro mechanical system (MEMS). The phase modulation-type spatial light modulator 153 can be operated to sequentially switch a location where projection light is projected, thereby concentrating energy on an image portion. Therefore, in a case where the phase modulation-type spatial light modulator 153 is used, an image can be displayed brighter than those in the other methods if the output of the light source 151 is the same as those in the other methods.

The image displayed on the modulation part 1530 of the spatial light modulator 153 is divided into a plurality of regions (also referred to as tiling). For example, the image displayed on the modulation part 1530 is divided into rectangular regions (also referred to as tiles) set to a desired aspect ratio. A phase image is allocated to each of the plurality of tiles set in the modulation part 1530. Each of the plurality of tiles includes a plurality of pixels. A phase image corresponding to an image to be projected is set to each of the plurality of tiles. The phase images set to the plurality of tiles may be the same or different.

A phase image is tiled to each of the plurality of tiles allocated to the modulation part 1530. For example, a phase image generated in advance is set to each of the plurality of tiles. When the modulation part 1530 is irradiated with the light 102 in a state where the phase images are set to the plurality of tiles, modulated light 103 that forms an image corresponding to a phase image of each tile is emitted. A larger number of tiles set in the modulation part 1530 make it possible to display a clearer image, but a smaller number of pixels of each tile results in a lower resolution. Therefore, the size and number of tiles set in the modulation part 1530 are set according to the application.

That is, a shield may be disposed on an optical path of the modulated light 103 modulated by the modulation part 1530 of the spatial light modulator 153. The shield is a frame that shields an unnecessary light component included in the modulated light 103 and defines an outer edge of a display area of projection light 105L and projection light 105R. For example, the shield is an aperture in which a slit-shaped opening is formed in a portion through which light forming a desired image passes. The shield allows light forming a desired image to pass therethrough and shields an unnecessary light component. For example, the shield shields zero-order light or a ghost image included in the modulated light 103.

The first curved mirror 155L is a reflecting mirror having a curved reflective surface 1550L. The reflective surface 1550L has a curvature in accordance with a projection angle of the projection light 105L. In the example of FIG. 13, the reflective surface 1550L has a shape like a side surface of a cylinder. For example, the reflective surface 1550L may be a spherical surface. For example, the reflective surface 1550L may be a free-form surface. For example, the reflective surface 1550L may have a shape in which a plurality of curved surfaces is combined rather than a single curved surface. For example, the reflective surface 1550L may have a shape in which a curved surface and a flat surface are combined.

The first curved mirror 155L is disposed on the optical path of the modulated light 103, with the reflective surface 1550L facing the modulation part 1530 of the spatial light modulator 153. A first optical path is formed between the light source 151, the modulation part 1530, and the reflective surface 1550L. The reflective surface 1550L is irradiated with the modulated light 103 modulated by the modulation part 1530. The light (broken line) reflected by the reflective surface 1550L is enlarged at an enlargement ratio corresponding to the curvature of the reflective surface 1550L. The light (broken line) enlarged according to the curvature of the reflective surface 1550L is converted into first circularly polarized light by passing through the first circular polarizer 158L. The converted first circularly polarized light is projected in a first direction (a leftward direction on the sheet of FIG. 13) (projection light 105L). In the example of FIG. 13, the projection light 105L is enlarged along the horizontal direction (the direction perpendicular to the sheet of FIG. 13) according to the curvature of the reflective surface 1550L in an irradiation range of the modulated light 103.

The folding mirror 156 is disposed on the optical path of the modulated light 103, with the reflective surface 1560 facing the modulation part 1530 of the spatial light modulator 153. The folding mirror 156 has a planar reflective surface 1560. That is, the folding mirror 156 is a flat mirror. The reflective surface 1560 of the folding mirror 156 is disposed toward the modulation part 1530 of the spatial light modulator 153 and a reflective surface 1550R of the second curved mirror 155R. The reflective surface 1560 is irradiated with a light component (solid line) emitted toward the reflective surface of the folding mirror 156 out of the modulated light 103 modulated by the modulation part 1530 of the spatial light modulator 153. A light component (broken line) emitted toward the first curved mirror 155L out of the modulated light 103 does not reach the reflective surface 1560 of the folding mirror 156. The modulated light 103 reflected by the reflective surface 1560 of the folding mirror 156 is constituted by a light component to be reflected by the reflective surface 1550R of the second curved mirror 155R and projected as projection light 105R in a second direction (a rightward direction of the sheet of FIG. 13).

For example, in a case where the modulated light 103 modulated by the modulation part 1530 of the spatial light modulator 153 is not enlarged, the first curved mirror 155L and the second curved mirror 155R may be omitted, and only the light in the Fraunhofer region may be used. In that case, the spatial light modulator 153 and the folding mirror 156 may be disposed in such a way that some light components of the modulated light 103 modulated by the modulation part 1530 of the spatial light modulator 153 are projected as they are, and the other light components are projected after being reflected by the reflective surface 1560 of the folding mirror 156.

The second curved mirror 155R is disposed on an optical path of light reflected by the reflective surface 1560, with the reflective surface 1550R facing the reflective surface 1560 of the folding mirror 156. A second optical path is formed between the light source 151, the modulation part 1530, the reflective surface 1560, and the reflective surface 1550R. The first optical path and the second optical path are preferably set to have the same optical path length. The reflective surface 1550R is irradiated with a light component (solid line) reflected by the reflective surface 1560 of the folding mirror 156 out of the modulated light 103 modulated by the modulation part 1530. The light (solid line) reflected by the reflective surface 1550R is enlarged at an enlargement ratio corresponding to the curvature of the reflective surface 1550R. The light (solid line) enlarged according to the curvature of the reflective surface 1550R is converted into second circularly polarized light by passing through the second circular polarizer 158R. The converted second circularly polarized light is projected in a second direction (a rightward direction on the sheet of FIG. 13) (projection light 105R). In the example of FIG. 13, the projection light 105R is enlarged along the horizontal direction (the direction perpendicular to the sheet of FIG. 13) according to the curvature of the reflective surface 1550R in an irradiation range of the modulated light 103.

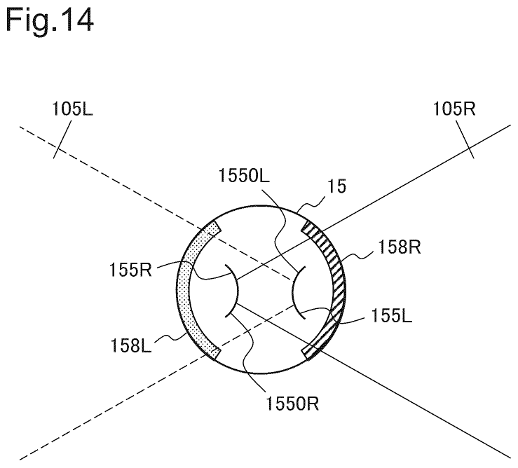

FIG. 14 is a conceptual diagram illustrating examples of a projection range of light (the projection light 105L) reflected by the reflective surface 1550L of the first curved mirror 155L and a projection of light (the projection light 105R) reflected by the reflective surface 1550R of the second curved mirror 155R. FIG. 14 is a view of the internal configuration of the transmission device 15 as viewed from above. In FIG. 14, components other than the first curved mirror 155L, the second curved mirror 155R, the first circular polarizer 158L, and the second circular polarizer 158R are omitted.

The modulated light 103 (broken line) reflected by the reflective surface 1550L of the first curved mirror 155L is enlarged at an enlargement ratio corresponding to the curvature of the reflective surface 1550L. The modulated light 103 enlarged according to the curvature of the reflective surface 1550L is converted into a counterclockwise circularly polarized optical signal (first circularly polarized optical signal) by passing through the first circular polarizer 158L, and is projected as projection light 105L.

The modulated light 103 (solid line) reflected by the reflective surface 1550R of the second curved mirror 155R is enlarged at an enlargement ratio corresponding to the curvature of the reflective surface 1550R. The modulated light 103 enlarged according to the curvature of the reflective surface 1550R is converted into a clockwise circularly polarized optical signal (second circularly polarized optical signal) by passing through the second circular polarizer 158R, and is projected as projection light 105R.

In the example of FIG. 14, the projection light 105L reflected by the reflective surface 1550L of the first curved mirror 155L is projected in the first direction (the leftward direction on the sheet of FIG. 14). In addition, the projection light 105R reflected by the reflective surface 1550R of the second curved mirror 155R is projected in the second direction (the rightward direction on the sheet of FIG. 14). For example, the first direction and the second direction are set to diametrically opposite directions. For example, the first direction and the second direction may be set to directions that are not diametrically opposite. For example, the communication device 10 may be configured to transmit spatial optical signals in four directions by combining two projection units that transmit spatial optical signals in diametrically opposite directions. For example, the communication device 10 may be configured to transmit spatial optical signals in a plurality of directions by combining three or more projection units.

The projection angle of the first circularly polarized optical signal (the projection light 105L) can be set by adjusting the curvature of the reflective surface 1550L of the first curved mirror 155L. Similarly, the projection angle of the second circularly polarized optical signal (the projection light 105R) can be set by adjusting the curvature of the reflective surface 1550R of the second curved mirror 155R. If the projection angle of each of the first circularly polarized optical signal (the projection light 105L) and the second circularly polarized optical signal (the projection light 105R) is set to 180 degrees, spatial optical signals can be transmitted in a 360-degree direction around the transmission device 15.

### [Communication Control Device]

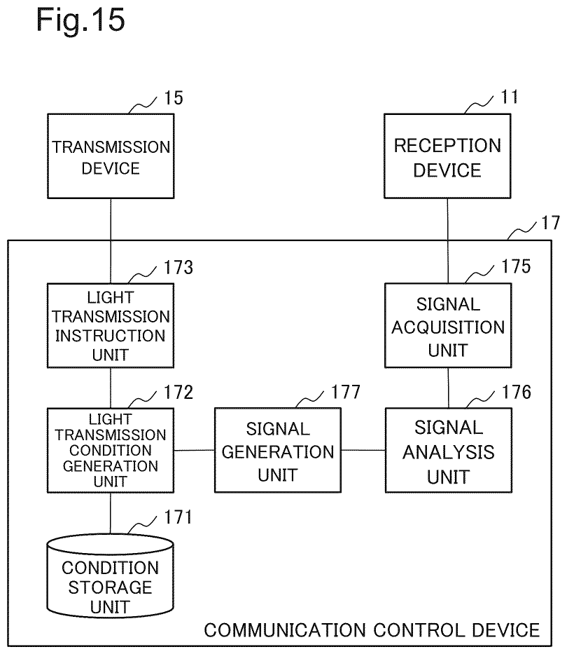

Next, a configuration of the communication control device 17 will be described with reference to the drawings. FIG. 15 is a block diagram for explaining an example of a configuration of the communication control device 17. The communication control device 17 includes a condition storage unit 171, a light transmission condition generation unit 172, a light transmission instruction unit 173, a signal acquisition unit 175, a signal analysis unit 176, and a signal generation unit 177. For example, the communication control device 17 is achieved by a microcomputer including a processor and a memory. The communication control device 17 may be mounted on a server or a cloud connected to the transmission device 15 or the reception device 11 via a network.

The condition storage unit 171 stores a pattern such as a phase image, a shift image, or a virtual lens image corresponding to projection light to be transmitted by the transmission device 15. The pattern stored in the condition storage unit 171 is set in the modulation part 1530 of the spatial light modulator 153. In addition, the condition storage unit 171 stores projection conditions including a light source control condition for controlling the light source 151 of the transmission device 15 and a modulator control condition for controlling the spatial light modulator 153 of the transmission device 15. The light source control condition is a condition including a timing at which the laser light 101 is emitted from the light source 151 of the transmission device 15. The modulator control condition is a condition for setting a pattern in the modulation part 1530 of the spatial light modulator 153. By coordinating the light source control condition and the modulator control condition, projection light corresponding to the pattern set in the modulation part 1530 of the spatial light modulator 153 is projected.

The light transmission condition generation unit 172 acquires a signal from the signal generation unit 177. The light transmission condition generation unit 172 generates a light transmission condition for transmitting information included in the acquired signal based on the conditions stored in the condition storage unit 171. For example, the light transmission condition generation unit 172 selects a pattern for transmitting information included in the acquired signal based on the projection conditions stored in the condition storage unit 171. For example, the light transmission condition generation unit 172 generates a light transmission condition under within a pattern corresponding to an image projected to transmit information included in the acquired signal is set in the modulation part 1530 of the spatial light modulator 153. For example, the light transmission condition generation unit 172 generates a light transmission condition under which a phase image corresponding to an image projected in accordance with an aspect ratio of a modulation region set in the modulation part 1530 of the spatial light modulator 153 is set in the modulation part 1530 of the spatial light modulator 153.

The light transmission instruction unit 173 outputs a light transmission instruction for controlling the light source 151 and the spatial light modulator 153 of the transmission device 15 to the transmission device 15 based on the light transmission condition set by the light transmission condition generation unit 172.

The signal acquisition unit 175 acquires a signal decoded by the reception circuit 116 of the reception device 11 from the reception device 11. Furthermore, the signal acquisition unit 175 acquires, from the reception device 11, a signal to which signal processing has been applied by the reception circuit 116 of the reception device 11. For example, the signal acquired by the signal acquisition unit 175 includes a communication counterpart scanned according to a spatial optical signal transmitted from the communication device 10 or a response transmitted from the communication counterpart during communication. The signal acquisition unit 175 outputs the acquired signal to the signal analysis unit 176.

The signal analysis unit 176 analyzes the signal acquired by the signal acquisition unit 175. For example, the signal analysis unit 176 analyzes information included in the signal according to the type of the signal. For example, the type of the signal includes a scan signal or a communication signal. The type of the signal analyzed by the signal analysis unit 176 is not particularly limited. The signal analysis unit 176 outputs a signal analysis result to the signal generation unit 177.

The signal generation unit 177 acquires the signal analysis result of the signal analysis unit 176. The signal generation unit 177 generates a transmission signal according to the signal analysis result. The transmission signal includes a content of communication with the communication counterpart and a content used for scanning the communication counterpart. The signal generation unit 177 generates a transmission signal for each communication counterpart. The signal generation unit 177 outputs the generated signal to the light transmission condition generation unit 172.

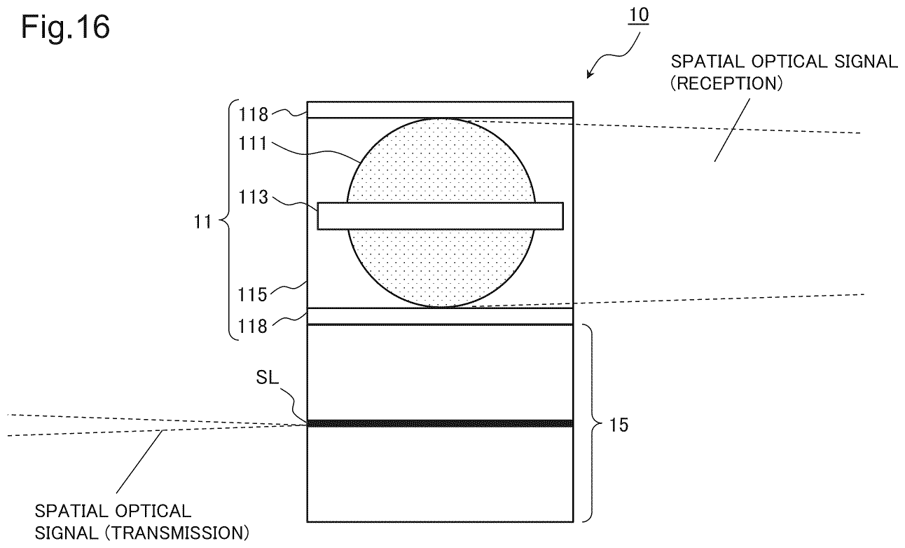

FIG. 16 is a conceptual diagram illustrating an example of a configuration of the communication device 10. The communication device 10 has a structure in which a cylindrical reception device 11 and a cylindrical transmission device 15 are stacked. In FIG. 15, the communication control device 17 is omitted. For example, the communication control device 17 is built in the communication device 10. FIG. 15 is an example of the configuration of the communication device 10, and does not limit the configuration for implementing the communication device 10.

The ball lens 111 is sandwiched between a pair of support members 118 arranged on the upper and lower sides thereof. The upper and lower sides of the ball lens 111 may be formed to have a planar shape in such a way as to be easily sandwiched by the support members 118, because they are not used for transmission and reception of spatial optical signals. A transparent cover 115 is disposed on a side surface of the cylindrical reception device 11. A spatial optical signal incident on the ball lens 111 through the transparent cover 115 is condensed on a condensing region of the ball lens 111 by the ball lens 111. The light receiving element 130 of the light receiving unit 113 is connected to the communication control device 17 by a conductive wire that is not illustrated. The transparent cover 115 is made of a material transparent to a spatial optical signal used for communication. For example, the transparent cover 115 may be made of a material that eliminates unnecessary light and selectively transmits a spatial optical signal used for communication. In a case where the communication device 10 is installed outdoors, the transparent cover 115 is preferably made of a material having high weather resistance. For example, the transparent cover 115 may have a portion having a function as a color filter that selectively allows a spatial optical signal to be received to pass therethrough. In an environment hardly affected by weather or the like, the transparent cover 115 may be omitted, and the ball lens 111 may be exposed to the outside.

The transmission device 15 transmits a spatial optical signal under the control of the communication control device 17. The light source 151 and the spatial light modulator 153 included in the transmission device 15 are connected to the communication control device 17 by conductive wires that are not illustrated. For example, a slit is formed in the housing 150 of the transmission device 15 so that a spatial optical signal can be projected in a 360-degree direction. For example, the transmission device 15 may have a configuration in which a plurality of units each including the light source 151, the spatial light modulator 153, the first curved mirror 155L, the second curved mirror 155R, and the folding mirror 156 are combined so that a spatial optical signal can be transmitted in a 360-degree direction.

The communication control device 17 is built in the communication device 10. For example, the communication control device 17 is configured on a substrate (not illustrated) disposed between the reception device 11 and the transmission device 15. The communication control device 17 causes the transmission device 15 to transmit a spatial optical signal according to an optical signal received by the light receiving unit 113, an instruction input by the user, a preset schedule, or the like.

### (System Configuration)

Next, an example of a configuration of the communication system 1 according to the present example embodiment will be described with reference to the drawings. Hereinafter, an example in which communication devices 10 are arranged one-dimensionally and an example in which communication devices 10 are arranged two-dimensionally will be described. The example of the configuration of the communication system 1 to be described below is an example, and does not limit the configuration of the communication system 1.

### First Configuration Example

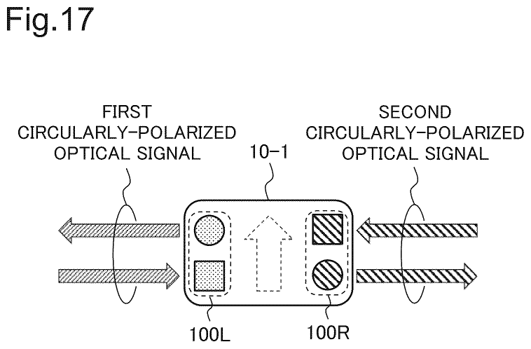

FIG. 17 is a conceptual diagram illustrating an example (communication device 10-1) of a communication device constituting a communication system according to a first configuration example. The communication device 10-1 includes a first transmission/reception unit 100L that transmits and receives a first circularly polarized optical signal and a second transmission/reception unit 100R that transmits and receives a second circularly polarized optical signal. The communication device 10-1 can transmit and receive spatial optical signals to and from a two-direction communication device 10-1. The direction in which the first transmission/reception unit 100L transmits and receives a first circularly polarized optical signal is opposite to the direction in which the second transmission/reception unit 100R transmits and receives a second circularly polarized optical signal.

In the example of FIG. 17, the first transmission/reception unit 100L is disposed on the left side of the communication device 10-1. The second transmission/reception unit 100R is disposed on the right side of the communication device 10-1. When the communication device 10-1 is rotated by 180 degrees within the plane of the sheet of FIG. 17, the first transmission/reception unit 100L is disposed on the right side of the communication device 10-1, and the second transmission/reception unit 100R is disposed on the left side of the communication device 10-1. In the communication device 10-1, arrows for clearly indicating the positional relationship between the first transmission/reception unit 100L and the second transmission/reception unit 100R are illustrated.

Although FIG. 17 illustrates an example in which a transmission part (o) and a reception part (u) where circularly polarized optical signals to be transmitted and received rotate in the same direction are combined, a transmission part (o) and a reception part (u) where circularly polarized optical signals to be transmitted and received rotate in different directions may be combined. For example, the transmission part (o) of the first transmission/reception unit 100L and the reception part (u) of the second transmission/reception unit 100R may be combined to transmit a first circularly polarized optical signal toward the upper side in the sheet of FIG. 17 and receive a second circularly polarized optical signal arriving from the upper side in the sheet of FIG. 17. For example, the reception part (u) of the first transmission/reception unit 100L and the transmission part (o) of the second transmission/reception unit 100R may be combined to transmit a second circularly polarized optical signal toward the lower side in the sheet of FIG. 17 and receive a first circularly polarized optical signal arriving from the lower side in the sheet of FIG. 17. The combination of the transmission part and the reception part constituting the transmission/reception part may be set between communication device 10-1 that transmits and receives circularly polarized optical signals to and from each other.

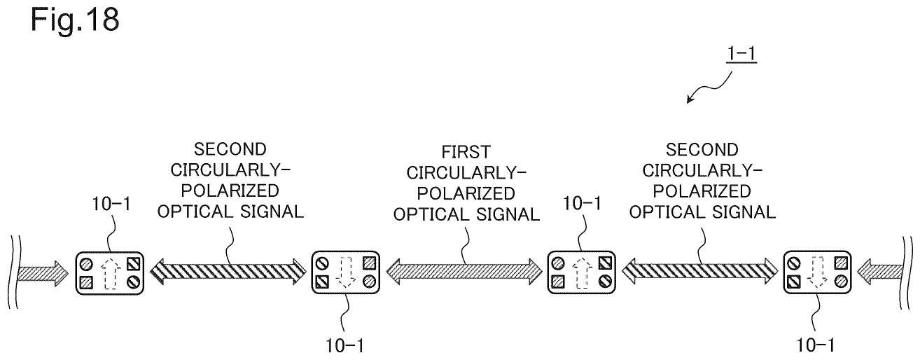

FIG. 18 is a conceptual diagram illustrating an example of a communication system 1-1 according to the first configuration example. The communication system 1-1 of FIG. 18 includes a plurality of communication devices 10-1 (FIG. 17) arranged one-dimensionally. The plurality of communication devices 10-1 are arranged in such a way that transmission/reception units that transmit and receive circularly polarized optical signals rotating in the same direction face each other between each of the communication devices and another adjacent communication device 10-1 that is a communication counterpart.

Among the plurality of communication devices 10-1, every two adjacent communication devices 10-1 transmit and receive circularly polarized optical signals rotating in the same direction to and from each other. The communication system 1-1 (FIG. 18) according to the present configuration example is capable of transmitting and receiving circularly polarized optical signals rotating in the same direction between the adjacent communication devices 10-1. On the other hand, since neighboring communication devices 10-1 between which one communication device 10-1 is interposed are different in rotation directions of circularly polarized optical signals, there is no interference. That is, according to the present configuration example, in the communication system 1-1 including a plurality of communication devices 10-1 arranged one-dimensionally with the same configuration, it is possible to suppress interference between spatial optical signals transmitted from the plurality of communication devices 10-1 in such a way as to arrive from the same direction and be directed in the same direction.

### Second Configuration Example

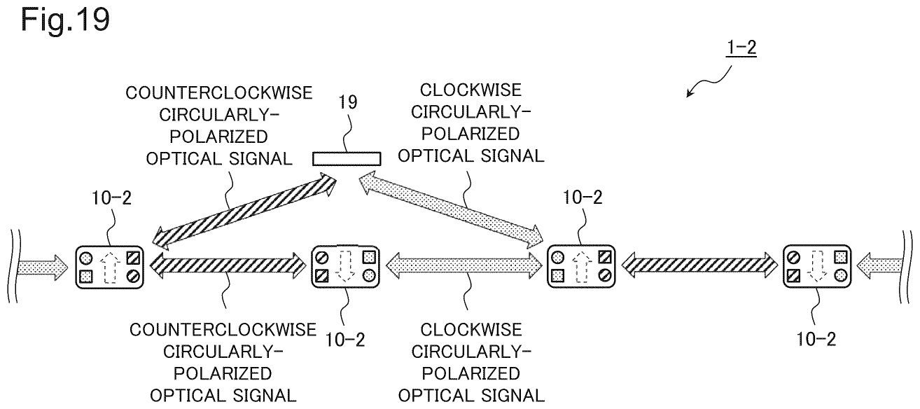

FIG. 19 is a conceptual diagram illustrating an example of a communication system 1-2 according to a second configuration example.

The communication system 1-2 of FIG. 19 includes a plurality of communication devices 10-2 arranged one-dimensionally. The communication devices 10-2 have a similar configuration to the communication devices 10-1 (FIG. 17) according to the first configuration example. The plurality of communication devices 10-2 are arranged in such a way that transmission/reception units that transmit and receive circularly polarized optical signals rotating in the same direction face each other between each of the communication devices and another adjacent communication device 10-2 that is a communication counterpart.

In the communication system 1-2, a mirror 19 having a reflective surface facing the direction in which the plurality of communication devices 10-2 are arranged. In the example of FIG. 19, the mirror 19 is disposed above the second leftmost communication device 10-2 with the reflective surface facing the second leftmost communication device 10-2. The mirror 19 is used for communication between neighboring communication devices 10-2 between which one communication device 10-2 is interposed. The mirror 19 may be disposed either above or below the communication device 10-1 with respect to the sheet of FIG. 19.

Among the plurality of communication devices 10-2, every two adjacent communication devices 10-2 transmit and receive circularly polarized optical signals rotating in the same direction to and from each other. The communication system 1-2 (FIG. 19) according to the present configuration example is capable of transmitting and receiving circularly polarized optical signals rotating in the same direction between the adjacent communication devices 10-2. On the other hand, since neighboring communication devices 10-2 between which one communication device 10-2 is interposed are different in rotation directions of circularly polarized optical signals, there is no interference between circularly polarized optical signals directly arriving from the neighboring communication devices 10-2.

Furthermore, in the communication system 1-2 (FIG. 19) according to the present configuration example, each of the leftmost communication device 10-2 and the second rightmost communication device 10-2 transmits and receives circularly polarized optical signals to and from a neighboring communication device 10-1 with one communication device interposed therebetween using the mirror 19. In addition, during a period when neighboring communication devices 10-1 with one communication device interposed therebetween communicate with each other, they do not communicate with communication devices 10-1 adjacent thereto. The circularly polarized optical signal reflected by the reflective surface of the mirror 19 rotates in the reverse rotation. Therefore, the communication system 1-2 (FIG. 19) according to the present configuration example is capable of receiving a circularly polarized optical signal transmitted from a neighboring communication device 10-1 with one communication device interposed by reflecting the circularly polarized optical signal using the reflective surface of the mirror 19. The communication device 10-1 may transmit a circularly polarized optical signal for communicating with a neighboring communication device 10-1 with one communication device interposed therebetween toward the reflective surface of the mirror 19. That is, according to the present configuration example, it is possible to configure a communication system 1-2 capable of communicating with a neighboring communication device 10-1 with one communication device interposed, while suppressing interference between spatial optical signals arriving from the same direction.

### Third Configuration Example

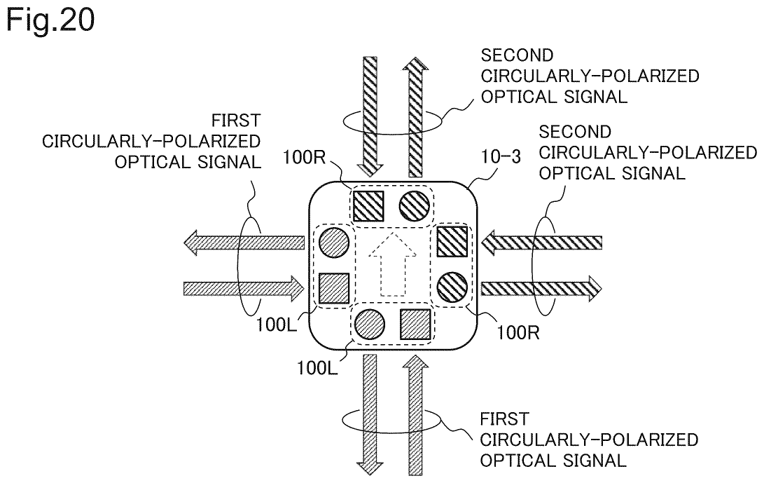

FIG. 20 is a conceptual diagram illustrating an example (communication device 10-3) of a communication device constituting a communication system of a third configuration example. The communication device 10-3 includes two first transmission/reception units 100L that transmit and receive first circularly polarized optical signals and two second transmission/reception units 100R that transmit and receive second circularly polarized optical signals. The communication device 10-3 can transmit and receive spatial optical signals to and from a four-direction communication device 10-3. In the two first transmission/reception units 100L, the directions in which spatial optical signals are transmitted are orthogonal to each other. Similarly, in the two second transmission/reception units 100R, the directions in which spatial optical signals are transmitted are orthogonal to each other.

In the example of FIG. 20, the first transmission/reception units 100L are disposed at two places on the left side and the lower side of the communication device 10-3. In addition, the second transmission/reception units 100R are disposed at two places on the right side and the upper side of the communication device 10-3. When the communication device 10-3 is rotated by 180 degrees within the plane of the sheet of FIG. 20, the first transmission/reception units 100L face the right side and the upper side of the communication device 10-3, and the second transmission/reception units 100R face the left side and the lower side of the communication device 10-3. In the communication device 10-3, arrows for clearly indicating the positional relationship between the first transmission/reception units 100L and the second transmission/reception units 100R are illustrated.

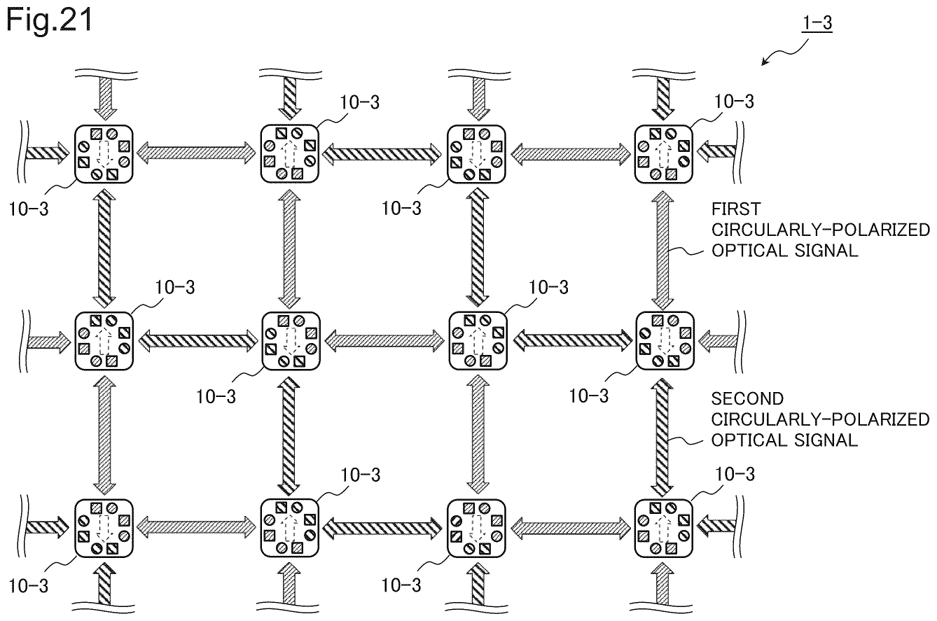

FIG. 21 is a conceptual diagram illustrating an example of a communication system 1-3 according to the third configuration example. The communication system 1-3 of FIG. 21 includes a plurality of communication devices 10-3 (FIG. 20) arranged in a lattice pattern. The plurality of communication devices 10-3 are arranged in a lattice pattern in such a way that transmission/reception units that transmit and receive circularly polarized optical signals rotating in the same direction face each other between each of the communication devices and another adjacent communication device 10-3 that is a communication counterpart.

Among the plurality of communication devices 10-3, every two adjacent communication devices 10-3 transmit and receive circularly polarized optical signals rotating in the same direction to and from each other. The communication system 1-3 (FIG. 21) according to the present configuration example is capable of transmitting and receiving circularly polarized optical signals rotating in the same direction between the adjacent communication devices 10-3. On the other hand, since neighboring communication devices 10-3 between which one communication device 10-3 is interposed are different in rotation directions of circularly polarized optical signals, there is no interference between spatial optical signals. That is, according to the present configuration example, it is possible to configure a communication system 1-3 capable of suppressing interference between spatial optical signals arriving from the same direction by using a plurality of communication devices 10-3 arranged in a lattice pattern with the same configuration. For example, the communication system 1-3 according to the third configuration example may be configured to transmit and receive spatial optical signals between neighboring communication devices 10-3 with one communication device interposed therebetween, by using the mirror 19 according to the second configuration example.

### Application Example

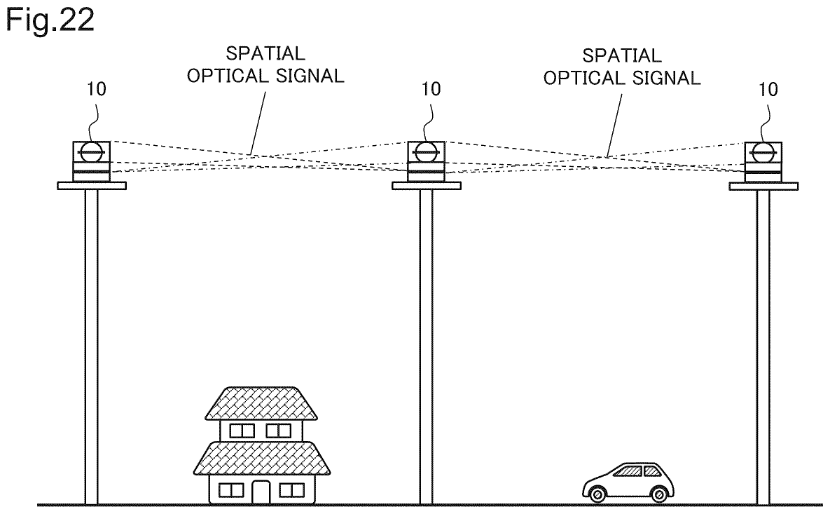

Next, an example in which the communication system 1 according to the present example embodiment is applied will be described with reference to the drawings. FIG. 22 is a conceptual diagram for explaining the present application example. In the present application example, a communication system 1 is configured by arranging a plurality of communication devices 10 at the tops of poles such as utility poles or street lamps. In the example of FIG. 22, a state in which spatial optical signals are transmitted in two directions from the communication device 10 is illustrated.

There are few obstacles at the tops of poles such as utility poles or street lamps. Therefore, the tops of poles such as utility poles or street lamps are suitable for installing the communication devices 10. In addition, if the communication devices 10 are installed at the same height at the tops of poles, the direction in which spatial optical signals arrive is limited to the horizontal direction, so that the light receiving area of the light receiving unit 113 included in the reception device 11 can be reduced and the devices can be simplified. Pairs of communication devices 10 that transmit and receive spatial optical signals are arranged to transmit and receive the spatial optical signals to and from each other. In a case where the communication system 1 includes a plurality of communication devices 10, the communication device 10 positioned in the middle may be disposed to relay a spatial optical signal transmitted from another communication device 10 to another communication device 10.

According to the present application example, the plurality of communication devices 10 installed on different poles can communicate with each other using spatial optical signals. For example, communication may be performed in a wireless manner between a wireless device installed in an automobile, a house, or the like or a base station and a communication device 10 according to communication between the communication devices 10 installed on the different poles. For example, the communication device 10 may be configured to be connected to the Internet via a communication cable or the like installed on a pole.

As described above, a communication system according to the present example embodiment includes a plurality of communication devices. The communication device includes a first transmission/reception unit and a second transmission/reception unit. The first transmission/reception unit transmits and receives counterclockwise first circularly polarized optical signals as spatial optical signals. The second transmission/reception unit transmits and receives clockwise second circularly polarized optical signals as spatial optical signals. The plurality of communication devices is arranged in such a way that, among the first transmission/reception units and the second transmission/reception units, transmission/reception units that transmit and receive circularly polarized optical signals rotating in the same direction face each other between each of the communication devices and another communication device that is a communication counterpart.

In the communication system according to the present example embodiment, transmission/reception units that transmit and receive circularly polarized optical signals rotating in the same direction face each other between each of the communication devices and another communication device that is a communication counterpart. For example, a circularly polarized optical signal transmitted from a communication device having a neighboring positional relationship with one communication device interposed is not received because its rotation direction is opposite to that of a circularly polarized optical signal from the communication counterpart. Therefore, the communication system according to the present example embodiment is capable of suppressing interference between spatial optical signals transmitted from a plurality of communication devices in such a way as to arrive from the same direction and to be directed in the same direction.

For example, there is a possibility that a spatial optical signal transmitted from a position farther than an adjacent communication device that is a communication counterpart arrives from the direction of the communication counterpart. An influence of interference in such a spatial optical signal due to factors such as the presence of the communication device that is a communication counterpart on the optical path and attenuation until reaching the communication device can be ignored. In order to more reliably prevent interference in a spatial optical signal transmitted from a position farther than the communication counterpart, an interval or a positional relationship between the plurality of communication devices may be set. For example, the influence of interference can be ignored, if an interval between the communication counterpart and a communication device other than the communication counterpart that transmits a circularly polarized optical signal rotating in the same direction from the same direction as the communication counterpart is larger than a distance at which the intensity of the spatial optical signal is equal to or smaller than the detection limit of the light receiving element. Furthermore, the influence of interference can be suppressed, if a positional relationship is established in such a way that another communication device is interposed between the communication counterpart and a communication device other than the communication counterpart that transmits a circularly polarized optical signal rotating in the same direction from the same direction as the communication counterpart. That is, in order to further suppress the influence of interference between spatial optical signals arriving from the same direction, a condition (also referred to as an arrangement condition) such as an interval or a positional relationship between the plurality of communication devices may be set in advance By arranging the plurality of communication devices according to the arrangement condition set in advance as described above, interference between spatial optical signals can be suppressed more reliably.

In an aspect of the present example embodiment, in the communication device, a direction in which the first circularly polarized optical signals are transmitted and received by the first transmission/reception unit is opposite to a direction in which the second circularly polarized optical signals are transmitted and received by the second transmission/reception unit. At least three communication devices among the plurality of communication devices is arranged on the same straight line. The at least three communication devices arranged on the same straight line are arranged in such a way that transmission/reception units that transmit and receive circularly polarized optical signals rotating in the same direction face each other between each of the at least three communication devices and another adjacent communication device. The at least three communication devices arranged on the same straight line are arranged in such a way that transmission/reception units that transmit and receive circularly polarized optical signals rotating in different directions face each other between each of the at least three communication devices and at least one other neighboring communication device of the communication devices. According to the present aspect, since circularly polarized optical signals transmitted from communication devices having a neighboring positional relationship with one communication device interposed therebetween are not received, it is possible to suppress interference between spatial optical signals transmitted from a plurality of communication devices in such a way as to arrive from the same direction and to be directed in the same direction.

In an aspect of the present example embodiment, the communication system further includes at least one mirror that reflects circularly polarized optical signals transmitted and received by at least two communication devices arranged in a neighboring positional relationship with one communication device interposed therebetween. According to the present aspect, by using the mirror, the rotation directions of the circularly polarized optical signals can be aligned each other between the communication devices arranged in the neighboring positional relationship with one communication device interposed therebetween. Therefore, according to the present aspect, communication can also be performed between the communication devices arranged in the neighboring positional relationship with one communication device interposed therebetween.

In an aspect of the present example embodiment, the communication device includes at least two pairs each including the first transmission/reception unit and the second transmission/reception unit from and to which first circularly polarized optical signals and second circularly polarized optical signals are transmitted and received in opposite directions. The plurality of communication devices is arranged in a lattice pattern. The plurality of communication devices arranged in the lattice pattern are arranged in such a way that transmission/reception units that transmit and receive circularly polarized optical signals rotating in the same direction face each other between each of the plurality of communication devices and another adjacent communication device. The plurality of communication devices arranged in the lattice pattern are arranged in such a way that transmission/reception units that transmit and receive circularly polarized optical signals rotating in different directions face each other between each of the plurality of communication devices and at least one other neighboring communication device of the communication devices. According to the present aspect, a communication system in which a plurality of communication devices is two-dimensionally arranged can be configured.

In an aspect of the present example embodiment, each of the first transmission/reception unit and the second transmission/reception unit of the communication device includes a transmission device and a reception device. The transmission device transmits at least one of the first circularly polarized optical signals or the second circularly polarized optical signals as a spatial optical signal to the another communication device that is the communication counterpart. The reception device converts a circularly polarized optical signal to be received into linearly polarized light, among the first circularly polarized optical signals or the second circularly polarized optical signals transmitted as the spatial optical signals from the another communication device that is the communication counterpart, receives the linearly polarized light, and outputs a signal corresponding to the received spatial optical signal. Furthermore, the communication device includes a communication control device. The communication control device controls the transmission device to transmit the first circularly polarized optical signal or the second circularly polarized optical signal as the spatial optical signals to the another communication device that is the communication counterpart, and acquires the signal output from the reception device. According to the present aspect, the communication control device can control the transmission devices and the reception devices included in the first transmission/reception unit and the second transmission/reception unit, thereby achieving optical spatial communication using spatial optical signals between the plurality of communication devices.

In an aspect of the present example embodiment, the reception device includes a lens, a first polarizer, a second polarizer, a light receiving unit, and a reception circuit. The lens condenses the spatial optical signal. The first polarizer has a configuration in which a first circularly polarizing plate that converts the first circularly polarized optical signal into the linearly polarized light and a first linearly polarizing plate that allows linearly polarized light to be received in the linearly polarized light converted by the first circularly polarizing plate to pass therethrough are combined. The second polarizer has a configuration in which a second circularly polarizing plate that converts the second circularly polarized optical signal into the linearly polarized light and a second linearly polarizing plate that allows linearly polarized light to be received among the linearly polarized light converted by the second circularly polarizing plate to pass therethrough are combined. The light receiving unit has a configuration in which light receiving elements, each having a light receiving portion sensitive to the spatial optical signal, are arranged in an array. The reception circuit decodes the signal corresponding to the spatial optical signal received by the plurality of light receiving elements constituting the light receiving unit. The first polarizer and the second polarizer are arranged in association with at least one of the plurality of light receiving elements. According to the present aspect, it is possible to achieve a communication device capable of transmitting and receiving first circularly polarized optical signals and second circularly polarized optical signals.

In an aspect of the present example embodiment, the lens is a ball lens that condenses the spatial optical signal on a condensing region. The plurality of light receiving elements are arranged in such a way as to surround a circumference of the ball lens with the light receiving portions facing the condensing region of the ball lens. The first polarizer is disposed in association with light receiving elements that receive the first circularly polarized optical signals transmitted from another communication device that transmits and receives the first circularly polarized optical signals. The second polarizer is disposed in association with light receiving elements that receive the second circularly polarized optical signals transmitted from another communication device that transmits and receives the second circularly polarized optical signals. According to the present aspect, since the light reception device includes the ball lens, it is possible to receive first circularly polarized optical signals and second circularly polarized optical signals arriving from a 360-degree direction.

In an aspect of the present example embodiment, the transmission device includes a light source, a first circular polarizer, and a second circular polarizer. The light source emits the linearly polarized light. The first circular polarizer converts the linearly polarized light emitted from the light source into the first circularly polarized optical signal. The second circular polarizer converts the linearly polarized light emitted from the light source into the second circularly polarized optical signal. The first circularly polarized optical signal and the second circularly polarized optical signal are transmitted in different directions. According to the present aspect, it is possible to achieve a transmission device capable of transmitting first circularly polarized optical signals and second circularly polarized optical signals in directions different.

In an aspect of the present example embodiment, the transmission device further includes a spatial light modulator, a first curved mirror, a second curved mirror, and a folding mirror. The spatial light modulator includes a modulation part irradiated with light emitted from the light source, the modulation part modulating a phase of the irradiated light. The first curved mirror has a curved first reflective surface. The second curved mirror has a curved second reflective surface. The folding mirror has a planar third reflective surface. The first curved mirror is disposed at a position irradiated with some light components of modulated light modulated by the modulation part, with the first reflective surface facing the modulation part of the spatial light modulator and the first circular polarizer. The first circular polarizer is disposed at a position through which the modulated light reflected by the first reflective surface of the first curved mirror passes. The first circular polarizer converts the modulated light reflected by the first curved mirror into the first circularly polarized signal. The folding mirror is disposed at a position irradiated with light components that are not emitted to the first curved mirror of the modulated light, with the third reflective surface facing the modulation part of the spatial light modulator and the second curved mirror. The folding mirror reflects the emitted modulated light toward the second curved mirror. The second curved mirror is disposed at a position irradiated with light components reflected by the folding mirror of the modulated light, with the second reflective surface facing the folding mirror and the second circular polarizer. The second circular polarizer is disposed at a position through which the modulated light reflected by the second reflective surface of the second curved mirror passes. The second circular polarizer converts the modulated light reflected by the second curved mirror into the second circularly polarized optical signal. According to the present aspect, it is possible to achieve a transmission device capable of transmitting first circularly polarized optical signals and second circularly polarized optical signals in two different directions.

In an aspect of the present example embodiment, the communication control device sets a phase image for forming a desired image in the modulation part of the spatial light modulator. The communication control device controls the light source in such a way as to irradiate the modulation part, in which the phase image is set, with the linearly polarized light. According to the present aspect, it is possible to achieve a transmission device capable of transmitting a spatial optical signal by setting a phase image in the modulation part of the spatial light modulator and controlling a timing at which light is emitted from the light source.

### Second Example Embodiment

Next, a communication system according to a second example embodiment will be described with reference to the drawings. The communication system according to the present example embodiment has a simplified configuration of the communication system according to the first example embodiment.

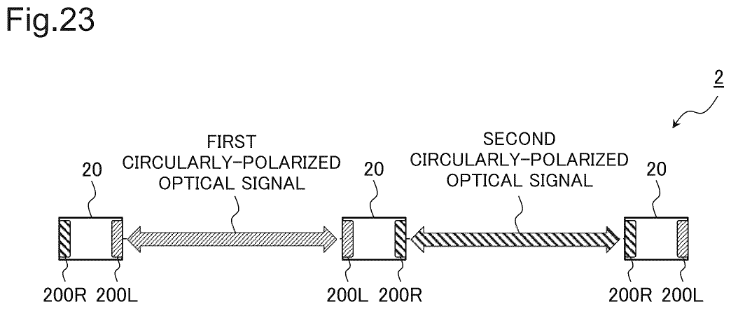

FIG. 23 is a conceptual diagram illustrating an example of a configuration of a communication system 2 according to the present example embodiment. The communication system 2 includes a plurality of communication devices 20. The communication device 20 includes a first transmission/reception unit 200L and a second transmission/reception unit 200R. The first transmission/reception unit 200L transmits and receives counterclockwise first circularly polarized optical signals as spatial optical signals. The second transmission/reception unit 200R transmits and receives clockwise second circularly polarized optical signals as spatial optical signals. The plurality of communication devices 20 are arranged in such a way that, among the first transmission/reception units 200L and the second transmission/reception units 200R, transmission/reception units that transmit and receive circularly polarized optical signals rotating in the same direction face each other between each of the communication devices and another communication device 20 that is a communication counterpart.

As described above, in the communication system according to the present example embodiment, transmission/reception units that transmit and receive circularly polarized optical signals rotating in the same direction face each other between each of the communication devices and another communication device that is a communication counterpart. For example, a circularly polarized optical signal transmitted from a communication device having a neighboring positional relationship with one communication device interposed is not received because its rotation direction is opposite to that of a circularly polarized optical signal from the communication counterpart. Therefore, the communication system according to the present example embodiment is capable of suppressing interference between spatial optical signals transmitted from a plurality of communication devices in such a way as to arrive from the same direction and to be directed in the same direction.

### (Hardware)

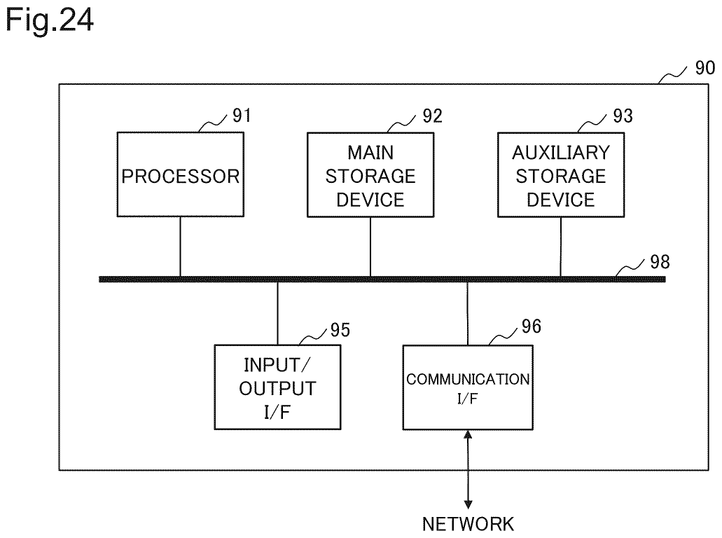

Here, a hardware configuration for executing the control or processing according to each of the above-described example embodiments of the present disclosure will be described using an information processing device 90 of FIG. 24 as an example. Note that the information processing device 90 of FIG. 24 is an example of the configuration for executing the control or processing according to each of the above-described example embodiments, and does not limit the scope of the present disclosure.

As illustrated in FIG. 24, the information processing device 90 includes a processor 91, a main storage device 92, an auxiliary storage device 93, an input/output interface 95, and a communication interface 96. In FIG. 24, an interface is abbreviated as an I/F. The processor 91, the main storage device 92, the auxiliary storage device 93, the input/output interface 95, and the communication interface 96 are connected to each other via a bus 98 for data communication therebetween. In addition, the processor 91, the main storage device 92, the auxiliary storage device 93, and the input/output interface 95 are connected to a network such as the Internet or an intranet via the communication interface 96.

The processor 91 develops a program stored in the auxiliary storage device 93 or the like in the main storage device 92. The processor 91 executes the program developed in the main storage device 92. In the present example embodiment, a software program installed in the information processing device 90 may be used. The processor 91 executes the control or processing according to each of the above-described example embodiments.

The main storage device 92 has an area in which a program is developed. A program stored in the auxiliary storage device 93 or the like is developed in the main storage device 92 by the processor 91. The main storage device 92 is achieved by, for example, a volatile memory such as a dynamic random access memory (DRAM). In addition, a nonvolatile memory such as a magnetoresistive random access memory (MRAM) may be included/added as the main storage device 92.

The auxiliary storage device 93 stores various data such as programs. The auxiliary storage device 93 is achieved by a local disk such as a hard disk or a flash memory. Note that various data may be stored in the main storage device 92, and the auxiliary storage device 93 may be omitted.

The input/output interface 95 is an interface for connecting the information processing device 90 and a peripheral device to each other in accordance with a standard or a specification. The communication interface 96 is an interface for connection to an external system or device through a network such as the Internet or an intranet in accordance with a standard or a specification. The input/output interface 95 and the communication interface 96 may be shared as an interface connected to an external device.

An input device such as a keyboard, a mouse, or a touch panel may be connected to the information processing device 90 if necessary. These input devices are used to input information and settings. In a case where the touch panel is used as an input device, a display screen of a display device may also serve as an interface of the input device. Data communication between the processor 91 and the input device may be mediated by the input/output interface 95.

Furthermore, the information processing device 90 may include a display device for displaying information. In a case where the information processing device 90 includes a display device, the information processing device 90 preferably includes a display control device (not illustrated) for controlling the display of the display device. The display device may be connected to the information processing device 90 via the input/output interface 95.

Furthermore, the information processing device 90 may be equipped with a drive device. Between the processor 91 and the recording medium (program recording medium), the drive device mediates reading of data or a program from the recording medium, writing of a processing result of the information processing device 90 to the recording medium, and the like. The drive device only needs to be connected to the information processing device 90 via the input/output interface 95.

An example of the hardware configuration for enabling the control or processing according to each of the above-described example embodiments of the present disclosure has been described above. Note that the hardware configuration of FIG. 24 is an example of the hardware configuration for executing the control or processing according to each of the above-described example embodiments, and does not limit the scope of the present disclosure. In addition, a program for causing a computer to execute the control or processing according to each of the above-described example embodiments also falls within the scope of the present disclosure. Furthermore, a program recording medium recording the program according to each of the above-described example embodiments also falls within the scope of the present disclosure. The recording medium can be achieved by, for example, an optical recording medium such as a compact disc (CD) or a digital versatile disc (DVD). The recording medium may be achieved by a semiconductor recording medium such as a universal serial bus (USB) memory or a secure digital (SD) card. Furthermore, the recording medium may be achieved by a magnetic recording medium such as a flexible disk, or another recording medium. In a case where a program executed by the processor is recorded in the recording medium, the recording medium is a program recording medium.

The components of the above-described example embodiments may be combined in any manner. In addition, the components that execute the control or processing of each of the above-described example embodiments may be achieved by software or by a circuit.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

1, 2 Communication system
10, 20 Communication device
11 Reception device
15 Transmission device
17 Communication control device
100L, 200L First transmission/reception unit
100R, 200R Second transmission/reception unit
110 Light receiver
111 Ball lens
113 Light receiving unit
114L First polarizer
114R Second polarizer
115 Transparent cover
116 Reception circuit
130 Light receiving element
141L First circularly polarizing plate 141L
141R Second circularly polarizing plate 141R
142L First linearly polarizing plate 142L
142R First linearly polarizing plate 142R
151 Light source
153 Spatial light modulator
155L First curved mirror
155R Second curved mirror
156 Folding mirror
158L First circular polarizer
158R Second circular polarizer
161 First processing circuit
162 Control circuit
163 Selector
165 Second processing circuit
171 Condition storage unit
172 Light transmission condition generation unit
173 Light transmission instruction unit
175 Signal acquisition unit
176 Signal analysis unit
177 Signal generation unit
1511 Emitter
1512 Lens

What is claimed is:

1. A communication system comprising a plurality of communication devices, each including a first transceiver configured to transmit and receive counterclockwise first circularly polarized optical signals as spatial optical signals and a second transceiver configured to transmit and receive clockwise second circularly polarized optical signals as spatial optical signals, wherein
the plurality of communication devices is arranged in such a way that, among a first transceivers and a second transceivers, transmission/reception parts that transmit and receive circularly polarized optical signals rotating in the same direction face each other between each of the communication devices and another communication device that is a communication counterpart.

2. The communication system according to claim 1, wherein
in the communication devices, a direction in which the first circularly polarized optical signals are transmitted and received by the first transceiver is opposite to a direction in which the second circularly polarized optical signals are transmitted and received by the second transceiver,
at least three communication devices among the plurality of communication devices is arranged on the same straight line,
the at least three communication devices arranged on the same straight line are arranged in such a way that the transmission/reception parts that transmit and receive the circularly polarized optical signals rotating in the same direction face each other between each of the at least three communication devices and adjacent another one of the communication devices, and
the at least three communication devices arranged on the same straight line are arranged in such a way that the transmission/reception parts that transmit and receive the circularly polarized optical signals rotating in different directions face each other between each of the at least three communication devices and at least one other neighboring communication device of the communication devices with one communication device interposed therebetween.

3. The communication system according to claim 2, further comprising
at least one mirror configured to reflect the circularly polarized optical signals transmitted and received by at least two of the communication devices arranged in a neighboring positional relationship with one communication device interposed therebetween.

4. The communication system according to claim 1, wherein
each of the communication devices includes at least two pairs, each including the first transceiver and the second transceiver from and to which first circularly polarized optical signals and second circularly polarized optical signals are transmitted and received in opposite directions,
the plurality of communication devices is arranged in a lattice pattern,
the plurality of communication devices arranged in the lattice pattern are arranged in such a way that the transmission/reception parts that transmit and receive the circularly polarized optical signals rotating in the same direction face each other between each of the plurality of communication devices and adjacent another one of the communication devices, and
the plurality of communication devices arranged in the lattice pattern are arranged in such a way that the transmission/reception parts that transmit and receive the circularly polarized optical signals rotating in different directions face each other between each of the plurality of communication devices and at least one other neighboring communication device of the communication devices with one communication device interposed therebetween.

5. The communication system according to claim 1, wherein
each of the first transceiver and the second transceiver of each of the communication devices includes:
a transmission device configured to transmit at least one of the first circularly polarized optical signals or the second circularly polarized optical signals as a spatial optical signal to the another communication device that is the communication counterpart; and
a reception device configured to convert a circularly polarized optical signal to be received into linearly polarized light, among the first circularly polarized optical signals or the second circularly polarized optical signals transmitted as spatial optical signals from the another communication device that is the communication counterpart, receive the linearly polarized light, and output a signal corresponding to the received spatial optical signal, and wherein
each of the communication devices includes a communication control device configured to control the transmission device to transmit the first circularly polarized optical signals and the second circularly polarized optical signals as the spatial optical signals to the another communication device that is the communication counterpart, and acquires the signal output from the reception device.

6. The communication system according to claim 5, wherein
the reception device includes:
a lens configured to condense the spatial optical signal;
a first polarizer in which a first circularly polarizing plate configured to convert the first circularly polarized optical signals into the linearly polarized light and a first linearly polarizing plate configured to allow linearly polarized light to be received, in the linearly polarized light converted by the first circularly polarizing plate, to pass therethrough are combined;
a second polarizer in which a second circularly polarizing plate configured to converts the second circularly polarized optical signals into the linearly polarized light and a second linearly polarizing plate configured to allow linearly polarized light to be received, in the linearly polarized light converted by the second circularly polarizing plate, to pass therethrough are combined;
a light receiver which light receiving elements, each having a light receiving portion sensitive to the spatial optical signal, are arranged in an array; and
a reception circuit configured to decode the signal corresponding to the spatial optical signal received by the plurality of light receiving elements constituting the light receiver, and
the first polarizer and the second polarizer are arranged in association with at least one of the plurality of light receiving elements.

7. The communication system according to claim 6, wherein
the lens is a ball lens configured to condense the spatial optical signal on a condensing region,
the plurality of light receiving elements are arranged in such a way as to surround a circumference of the ball lens with the light receiving portions facing the condensing region of the ball lens,
the first polarizer is disposed in association with the light receiving elements that receive the first circularly polarized optical signals transmitted from another one of the communication devices that transmits and receives the first circularly polarized optical signals, and
the second polarizer is disposed in association with light receiving elements that receive the second circularly polarized optical signals transmitted from another one of the communication devices that transmits and receives the second circularly polarized optical signals.

8. The communication system according to claim 5, wherein
the transmission device includes:
a light source configured to emit the linearly polarized light;
a first circular polarizer configured to convert the linearly polarized light emitted from the light source into the first circularly polarized optical signal; and
a second circular polarizer configured to convert the linearly polarized light emitted from the light source into the second circularly polarized optical signal, and
the first circularly polarized optical signal and the second circularly polarized optical signal are transmitted in different directions.

9. The communication system according to claim 8, wherein
the transmission device further includes:
a spatial light modulator including a modulation part irradiated with light emitted from the light source, the modulation part being configured to modulate a phase of the irradiated light;
a first curved mirror having a curved first reflective surface;
a second curved mirror having a curved second reflective surface; and
a folding mirror having a planar third reflective surface,
the first curved mirror is disposed at a position irradiated with some light components of modulated light modulated by the modulation part, with the first reflective surface facing the modulation part of the spatial light modulator and the first circular polarizer,
the first circular polarizer is disposed at a position through which the modulated light reflected by the first reflective surface of the first curved mirror passes to convert the modulated light reflected by the first curved mirror into the first circularly polarized optical signal,
the folding mirror is disposed at a position irradiated with light components that are not emitted to the first curved mirror of the modulated light, with the third reflective surface facing the modulation part of the spatial light modulator and the second curved mirror,
the folding mirror reflects the emitted modulated light toward the second curved mirror,
the second curved mirror is disposed at a position irradiated with light components reflected by the folding mirror of the modulated light, with the second reflective surface facing the folding mirror and the second circular polarizer, and
the second circular polarizer is disposed at a position through which the modulated light reflected by the second reflective surface of the second curved mirror passes to convert the modulated light reflected by the second curved mirror into the second circularly polarized signal.

10. The communication system according to claim 9, wherein
the communication control device comprises
a memory storing instructions; and
a processor connected to the memory and configured to execute the instructions to
set a phase image for forming a desired image in the modulation part of the spatial light modulator, and
control the light source in such a way as to irradiate the modulation part, in which the phase image is set, with the linearly polarized light.
